(19) United States
(12) Patent Application Publication
(10) Pub. No.: US 2006/0116309 A1
(43) Pub. Date: Jun. 1, 2006

(54) Detergent or cleaning agent

(76) Inventors: Alexander Lambotte, Duesseldorf (DE); Ulrich Pegelow, Duesseldorf (DE); Maren Jekel, Willich (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/236,389

(22) Filed: Sep. 26, 2005

Related U.S. Application Data
(63) Continuation of application No. PCT/EP04/02722, filed on Mar. 17, 2004.

(30) Foreign Application Priority Data
Mar. 25, 2003 (DE) 103 13 458.1

(51) Int. Cl. C11D 3/395

(52) U.S. Cl. 510/302

(57) ABSTRACT

Detergents or cleaning agents in the form of a combined product comprising—a first active detergent preparation in the form of a dispersion of solid particles in a dispersing agent, said preparation containing i) 10 to 90 percent by weight of dispersing agent, and ii) 10 to 90 percent by weight of dispersed substances, the percentages being in relation to the total weight of the dispersion, —and at least one additional active detergent preparation which dissolves faster in water at 40° C. than the first active detergent preparation. The inventive detergents or cleaning agents are characterized by improved cleaning power.

### CROSS-REFERENCE TO RELATED APPLICATIONS

This application is a continuation under 35 U.S.C. § 120 of international application PCT/EP2004/002722, filed Mar. 17, 2004. This application also claims priority under 35 U.S.C. § 119 of DE 103 13 458.1, filed Mar. 25, 2003, which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

This application relates to detergent or cleaning agents. In particular, this application relates to detergents or cleaning agents, which are the combined product of two different mixtures of substances of specific composition and in which these mixtures of substances exhibit different solubilities.

Nowadays, detergent or cleaning agents are available to the consumer in a variety of commercial forms. In addition to washing powders and granulates, this range also includes, for example detergent concentrates in the form of extruded or tableted compositions. These solid, concentrated or densified commercial forms are characterized by a reduced volume per unit of dose and thereby lower transport and packaging costs. In particular, such detergent or cleaning agent tablets also fulfil the wish of the consumer for easy dosing. Such agents are extensively described in the prior art. Other than the described commercial forms, detergent or cleaning agents are also additionally made up as gels or pastes.

(2) Description of Related Art, Including Information Disclosed Under 37 C.F.R. §§ 1.97 and 1.98.

Thus, the granted Patent EP 331 370 (Unilever) discloses a process for the manufacture of stable, viscous, liquid compositions for use in automatic dishwashers.

The subject of the European Patent EP 797 656 (Unilever) is non-aqueous liquid detergent compositions, which comprise polymeric hydrotropes.

In addition to other materials, water-soluble or water-dispersible films are particularly suitable for packaging solid or liquid detergent or cleaning agents. Detergents packaged in this way as individual dosage units can be easily dosed by introducing one or more sachets directly into the washing or dishwashing machine or into their dispensing draw, or by throwing them into a defined amount of water, for example in a bucket or in a wash basin or rinsing basin. These types of packaged detergent or cleaning agents are the subject of numerous publications.

The granted European Patent EP 700 989 B1 claims, for example, a cleaning agent for dishwashing packaged in individual units, wherein the cleaning agent that is packaged as a single unit is enclosed in a packaging made from a water-soluble material, which is sticky on its exterior sides.

Application WO 02/16222/Reckitt-Benckiser) discloses water-soluble packaging for aqueous cleaning agent compositions, whose free water content is at least 3 wt. %.

The subject of WO 02/16541 (Reckitt-Benckiser) is liquid cleaning agent compositions with a water content between 20 and 50 wt. %, which are packaged in a water-soluble or water-dispersible material, comprise at least one polyphosphate builder and are characterized by a specific ratio of potassium and sodium ions contained in the composition.

In spite of the numerous publications in the field of detergent or cleaning agents, there still remains the need for an improvement in the cleaning performance of these agents, particularly with regard to maintaining or reducing the added quantities of active detergent or cleaning substances per washing or cleaning cycle.

### BRIEF SUMMARY OF THE INVENTION

A first object of the present invention was the improvement in cleaning performance of detergent or cleaning agents. In this regard, both the elimination of stains should be improved as well as an increased efficiency of additives such as glass or silver protection agents.

A further object of the present invention was the preparation of a high-density detergent or cleaning agent, which simultaneously possesses a high solubility. Solid detergent or cleaning agents should also possess a high dimensional stability as well as a reduced tendency to breakage. Such highly densified detergent or cleaning agents assume a reduced volume per unit dose, and are therefore compatible with a greater number of dispensing chambers of commercial washing machines or dishwashers.

Finally, a manufactured shape for detergent or cleaning agents should be made available, which can be easily shaped in production. Particular limitations with respect to the geometric shape of the manufactured agent should be circumvented, such as, for example, in the manufacturing process as is typical for tableting.

It has now been found that detergent or cleaning agents, which are a combined product of at least one dispersion and at least one additional composition of active substances, wherein the dispersion dissolves more slowly than the at least one additional composition of active substances, can achieve at least some of the mentioned objects.

Accordingly, a first embodiment of the present application is a detergent or cleaning agent comprising

A first active detergent or cleaning preparation in the form of a dispersion of solid particles in a dispersion agent, which based on its total weight, comprises
i) 10 to 65 wt. % dispersion agent and
ii) 30 to 90 wt. % dispersed materials,
wherein the detergent or cleaning agent comprises at least an additional detergent or cleaning agent preparation that dissolves faster in water at 40° C. than the first active detergent or cleaning preparation.

### BRIEF DESCRIPTION OF THE SEVERAL VIEWS OF THE DRAWINGS

Not Applicable

### DETAILED DESCRIPTION OF THE INVENTION

A dispersion in this application is described as a multi-phase system having a continuous phase (dispersion agent) and at least one additionally finely divided phase (dispersed material).

Particularly preferred inventive detergent or cleaning agents are characterized in that they comprise the dispersion agent in quantities above 11% by weight, preferably above 13% by weight, particularly preferably above 15% by weight, quite particularly preferably above 17% by weight, and in particular above 19% by weight, each based on the total weight of the dispersion. Furthermore, realizable and equally preferred are inventive agents, which possess a dispersion with a weight proportion of dispersion agent above 20 wt. %, preferably above 21 wt. % and in particular above 22 wt. %, each based on the total weight of the dispersion. The maximum content of preferred inventive dispersions in dispersion agents, based on the total weight of the dispersion, is preferably less than 63 wt. %, more preferably less than 57 wt. %, particularly preferably less than 52 wt. %, quite particularly preferably less than 47 wt. % and in particular less than 37 wt. %. For the purposes of the present invention, such detergent and cleaning agents are particularly preferred that comprise, based on their total weight, dispersion agents in quantities of 12 to 62 wt. %, preferably 17 to 49 wt. % and in particular 23 to 38 wt. %.

The added dispersion agents are preferably water-soluble or water-dispersible. The solubility of these dispersion agents at 25° C. is here advantageously more than 200 g/l, preferably more than 300 g/l, particularly preferably more than 400 g/l, quite particularly preferably between 430 and 620 g/l and in particular between 470 and 580 g/l.

Consequently, the dispersions comprised in the inventive detergents or cleaning agents are fast-dissolving. Preferred dispersions are characterized in that they dissolve in water (40° C.) in less than 12 minutes, advantageously in less than 10 minutes, preferably in less than 9 minutes and particularly preferably in less than 8 minutes and in particular in less than 7 minutes. In order to determine the solubility, 20 g of the dispersion is placed in the interior of a dishwasher (MIELE G 646 PLUS). The main cleaning cycle of a standard cleaning program (45° C.) is started. The solubility determination is made by measuring the conductivity, displayed using a conductivity sensor. The dissolving process ends at the conductivity maximum. This maximum corresponds to a plateau in the conductivity diagram. The conductivity measurement begins when the circulation pump in the main cleaning cycle switches on. The added quantity of water is 5 liters.

Inventive combined products are characterized in that the solid or liquid additional active detergent or cleaning preparation dissolves faster than the dispersion. The previously described conductivity method is suitable for determining the solubility of the additional detergent or cleaning agent composition. The difference of the solubilities between at least one dispersion and at least one active detergent or cleaning preparation in preferred inventive agents is at least 20 seconds, advantageously at least 40 seconds, preferably at least 60 seconds, quite particularly preferably at least 90 seconds and in particular 120 seconds.

From the previous statements, it is clear that the inventive added dispersions are not the melted bodies known from the prior art. It is much more important to state that the inventive dispersions advantageously comprise less than 5 wt. %, preferably less than 3 wt. %, particularly preferably less than 1 wt. % and in particular no waxes and/or fat(s) and/or triglyceride(s) and/or fatty acids and/or fatty alcohols or other high-melting, water-insoluble ingredients.

Fat(s) and/or triglyceride(s) is the term for compounds of glycerol, in which the three hydroxy groups of glycerol are esterified with carboxylic acids. Naturally occurring fats are triglycerides, which generally contain different fatty acids in the same glycerol molecule. Saponification of the fats and subsequent esterification or reaction with acyl chlorides enable synthetic triglycerides to be obtained in which only one fatty acid is present (e.g. tripalmitine. trioleine or tristearine). Inventive dispersions comprise in the main no natural and/or synthetic fats and/or mixtures of both. The content by weight of fats to the total weight of the inventive dispersions in dispersion agents, is advantageously less than 4 wt. %, preferably less than 3 wt. %, particularly preferably less than 2 wt. %, quite particularly preferably less than 1 wt. % and in particular less than 0.5 wt. %. Dispersions, which comprise no fats, are particularly preferred.

In the present application, fatty acids are termed aliphatic saturated or unsaturated carboxylic acids with branched or unbranched carbon chains. There exist a number of production methods to manufacture fatty acids. Whereas lower fatty acids are mostly synthesized using oxidative processes starting from alcohols and/or aldehydes and aliphatic or acyclic hydrocarbons, the higher homologs are mostly obtainable, still today, by saponifying natural fats. Advances in the field of transgenic plants have now provided almost unlimited possibilities for varying the fatty acid spectrum in the stored fats of plant oils. Capric acid, undecanoic acid, lauric acid, tridecanoic acid, myristic acid, pentadecanoic acid, palmitic acid, margaric acid, stearic acid, nonadecanoic acid, arachic acid, erucanoic acid, elaeosteraric acid are examples of such fatty acids.

Fatty alcohol is a collective term for linear, saturated or unsaturated primary alcohols having 6 to 22 carbon atoms that were obtained by reducing triglycerides, fatty acids or fatty acid esters. Depending on the manufacturing process, the fatty alcohols can be saturated or unsaturated. Myristyl alcohol, 1-pentadecanol, cetyl alcohol, 1-heptadecanol, stearyl alcohol, erucyl alcohol, 1-nonadecanol, arachidyl alcohol, 1-heneicosanol, behenyl alcohol, erucyl alcohol, brassidyl alcohol are examples of such fatty alcohols.

Dispersions comprise in the main no fatty acids and/or fatty alcohols and/or mixtures of both. The content by weight of fatty acids and/or fatty alcohols to the total weight of the inventive dispersions in dispersion agents, is advantageously less than 4 wt. %, preferably less than 3 wt. %, particularly preferably less than 2 wt. %, quite particularly preferably less than 1 wt. % and in particular less than 0.5 wt. %. Dispersions, which comprise no fatty acids and/or fatty alcohols, are particularly preferred.

“Waxes” are understood to mean a series of natural or synthetic materials that in general melt without decomposition above 40° C. and already a little above their melting point are of relatively low viscosity and cannot be spun into threads. They exhibit a strongly temperature-dependent consistence and solubility. Waxes are subdivided into three groups depending on their origin, natural waxes, chemically modified waxes and synthetic waxes.

Natural waxes include, for example, plant waxes, such as candelilla wax, carnauba wax, Japan wax, esparto grass wax, cork wax, guaruma wax, rice germ oil wax, sugarcane wax, ouricury wax, or montan wax, animal waxes, such as beeswax, shellac wax, spermaceti, lanolin (wool wax), or uropygial grease, mineral waxes, such as ceresin or ozokerite (earth wax), or petrochemical waxes, such as petrolatum, paraffin waxes or microcrystalline waxes.

Chemically modified waxes include, for example, hard waxes, such as montan ester waxes, Sassol waxes or hydrogenated jojoba waxes.

Synthetic waxes are understood to mean for example, higher esters of phthalic acid, particularly dicyclohexyl phthalate, commercially available under the name Unimoll® 66 (Bayer AG), similarly, the waxes synthesized from lower carboxylic acids and fatty alcohols, for example dimyristyl tartrate, which is available under the name Cosmacol® ETLP (Condea). On the other hand, synthetic or partially synthetic esters of lower alcohols and naturally sourced fatty acids also fall into the group of synthetic waxes. Tegin® 90 (Goldschmidt), a glycerin monostearate-palmitate, or shellac, for example Shellack-KPS-Dreiring-SP (Kalkhoff GmbH) fall into this material class.

In the context of the present invention, the so-called wax alcohols, for example, are also counted as waxes. Wax alcohols are high molecular, water-insoluble fatty alcohols with generally about 22 to 40 carbon atoms. The wax alcohols are found, for example, in the form of wax esters of high molecular fatty acids (wax acids) as the major constituent of many natural waxes. Examples of wax alcohols are lignoceryl alcohol (1-tetracosanol), cetyl alcohol, myristyl alcohol or melissyl alcohol. Preferred dispersions comprise in the main no waxes as dispersion agents. The content by weight of waxes to the total weight of the dispersions is advantageously less than 4 wt. %, preferably less than 3 wt. %, particularly preferably less than 2 wt. %, quite particularly preferably less than 1 wt. % and in particular less than 0.5 wt. %. Dispersions, which comprise no waxes, are particularly preferred.

In a further preferred embodiment, the dispersions comprise in the main no paraffin wax (paraffins) as dispersion aids. Paraffin waxes mainly consist of alkanes, together with lower amounts of iso and cycloalkanes. The content by weight of paraffin waxes to the total weight of the inventive dispersions is advantageously less than 4 wt. %, preferably less than 3 wt. %, particularly preferably less than 2 wt. %, quite particularly preferably less than 1 wt. % and in particular less than 0.5 wt. %. Dispersions, which comprise no paraffin waxes, are particularly preferred.

Water-soluble or water-dispersible polymers, particularly the water-soluble or water-dispersible non-ionic polymers are preferred dispersion agents in the context of the present invention. In a preferred embodiment of the present invention, at least one dispersion agent is selected from the group of water-soluble or water-dispersible non-ionic polymers. The dispersion agent can be both a single polymer as well as a mixture of different water-soluble or water-dispersible non-ionic polymers. In a further preferred embodiment of the present invention, the dispersion agent or at least 50 wt. % of the polymer mixture consists of water-soluble or water-dispersible non-ionic polymers from the group of polyvinyl pyrrolidones, vinyl pyrrolidone/vinyl ester-copolymers, cellulose ethers, polyvinyl alcohols, polyalkylene glycols, particularly polyethylene glycol and/or polypropylene glycol.

In the context of the invention, preferred dispersion agents are polyvinyl pyrrolidones. Polyvinyl pyrrolidones [poly(1-vinyl-2-pyrrolidinones)], abbreviated PVP, are polymers of the general formula (I) 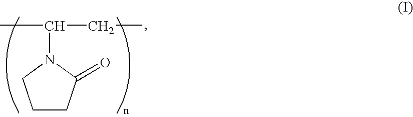
prepared by free-radical polymerization of 1-vinyl pyrrolidone by solution or suspension polymerization processes using free-radical initiators (peroxides, azo compounds). The ionic polymerization of the monomer yields only products with low molecular weights. Commercial polyvinyl pyrrolidones have molecular weights in the range ca. 2500-750 000 g/mol, characterized by their K-values and depending on the K-value have glass transition temperatures from 130-175°. They are supplied as white, hygroscopic powders or as aqueous solutions. Polyvinyl pyrrolidones are readily soluble in water and a large number of organic solvents (alcohols, ketones, glacial acetic acid, chlorinated hydrocarbons, phenols, etc).

Vinyl pyrrolidone-vinyl ester copolymers, such as, for example, those marketed by BASF under the trade name Luviskol®, Luviskol® VA 64 and Luviskol® VA 73, each vinyl pyrrolidone-vinyl acetate copolymers, are likewise preferred non-ionic polymers.

The vinyl ester polymers are polymers obtainable from vinyl esters with the groups of formula (II) 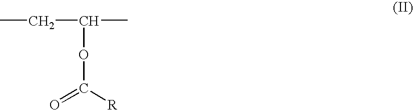
as the characteristic basic structural unit of the macromolecules. Of these, the vinyl acetate polymers (R═CH₃) with polyvinyl acetates are by far the most important representatives and have the greatest industrial significance.

Polymerization of vinyl esters occurs radically according to different processes (solution polymerization, suspension polymerization, emulsion polymerization, substance polymerization). Copolymers of vinyl acetate with vinyl pyrrolidone comprise monomer units of Formula (I) and (II)

Cellulose ethers, such as hydroxypropyl cellulose, hydroxyethyl cellulose and methyl hydroxypropyl cellulose, are marketed for example under the trademarks Culminal® and Benecel® (AQUALON).

Cellulose ethers can be described by means of the general Formula: 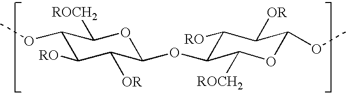
in which R stands for H or an alkyl, alkenyl, alkynyl, aryl or alkylaryl radical. In preferred products, at least one R stands for —CH₂CH₂CH₂—OH or —CH₂CH₂—OH in the Formula. Cellulose ethers are prepared industrially by etherifying alkali cellulose (e.g., with ethylene oxide). Cellulose ethers are characterized by way of the average degree of substitution, DS, and/or by the molar degree of substitution, MS, which indicate how many hydroxyl groups of an anhydroglucose unit of cellulose have reacted with the etherifying reagent or how many moles of the etherifying reagent have been added on, on average, to one anhydroglucose unit. Hydroxyethyl celluloses are water-soluble above a DS of approximately 0.6 and an MS of approximately 1. Typical commercial hydroxyethyl and hydroxypropyl celluloses have degrees of substitution in the range of 0.85-.1.35 (DS) and 1.5-3 (MS), respectively. Hydroxyethyl and hydroxypropyl celluloses are marketed as yellow-white, odorless and tasteless powders with vastly different degrees of polymerization. Hydroxyethyl and hydroxypropyl celluloses are soluble in cold and hot water and in some (water-containing) organic solvents, but insoluble in the majority of (anhydrous) organic solvents; their aqueous solutions are relatively insensitive to changes in pH or addition of electrolyte.

Polyvinyl alcohols, abbreviated PVAL, are polymers of the general structure
[—CH₂—CH(OH)—]ₙ
which comprise lesser amounts (ca. 2%) of structural units of the type
[—CH₂—CH(OH)—CH(OH)—CH₂]
As the corresponding monomer, vinyl alcohol, is unstable in its free state, polyvinyl alcohols are manufactured using polymer-analogous reactions by hydrolysis, industrially however especially by alkaline catalysed transesterification of polyvinyl acetates with alcohols (preferably methanol) in solution. PVAL, with a predefined, residual content of acetate groups, are also obtainable by this industrial process.

Commercial PVAL (e.g. Mowiol®-types of Hoechst) are available as white-yellow powder or granulates with degrees of polymerization in the range ca. 500-2500 (corresponding to molecular weights of ca. 20 000-100 000 g/mol) and have varying degrees of hydrolysis in the range 98-99 or 87-89 mole %. They are therefore partially hydrolyzed polyvinyl acetates with a ca. 1-2 or 11-13 mole % residual content of acetyl groups.

Polyethylene glycols and polypropylene glycols are particularly suitable as polyalkylene glycols. Polymers of ethylene glycols satisfy the general Formula III
H—(O—CH₂—CH₂)n-OH (III)
wherein n can assume values between 1 (ethylene glycol) and several thousand. There exist different nomenclatures for polyethylene glycols, which can lead to confusion. It is common industrial practice to indicate the mean relative molecular weight after the initials “PEG,” so that “PEG 200” characterizes a polyethylene glycol having a relative molecular weight of about 190 to about 210. Cosmetic ingredients are covered by another nomenclature in which the initials PEG are followed by a hyphen and the hyphen is in turn directly followed by a number which corresponds to the index n in the above Formula. Under this nomenclature (so-called INCI nomenclature, CTFA International Cosmetic Ingredient Dictionary and Handbook, 5^{th} Edition, The Cosmetic, Toiletry and Fragrance Association, Washington, 1997), PEG-4, PEG-6, PEG-8, PEG-9, PEG-10, PEG-12, PEG-14 and PEG-16 for example, are suitable. Polyethylene glycols are commercially obtainable, for example under the trade names of Carbowax® PEG 200 (Union Carbide), Emkapol® 200 (ICI Americas), Lipoxol® 200 MED (HULS America), Polyglycol® E-200 (Dow Chemical), Alkapol® PEG 300 (Rhone-Poulenc), Lutrol® E300 (BASF) and the corresponding trade names with higher numbers. The average relative molecular weight of at least one of the dispersion agents added in the inventive detergent or cleaning agents, particularly of at least one of the added polyalkylene glycols, ranges from 200 to 36 000, preferably between 200 and 6000 and particularly preferably between 300 and 5000.

Polypropylene glycols (abb. PPG) are polymers of propylene glycol, which correspond to the general Formula (IV) 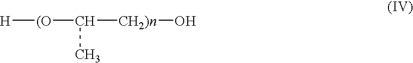
wherein n can assume values between 1 (propylene glycol) and several thousand. In this case the industrially significant representatives are, in particular, di-, tri- and tetrapropylene glycol, i.e., the representatives where n=2, 3 and 4 in Formula IV.

Particularly preferred inventive detergent or cleaning agents comprise a non-ionic polymer, preferably a polyalkylene glycol, most preferably a polyethylene glycol and/or a polypropylene glycol, as the dispersion agent, the proportion by weight of the polyethylene glycol to the total weight of all dispersion agents being preferably between 10 and 90 wt. %, particularly preferably between 30 and 80 wt. % and in particular between 50 and 70 wt. %. Particularly preferred inventive detergent or cleaning agents are those where the dispersion agent consists of more than 92% by weight, preferably more than 94% by weight, particularly preferably more than 96% by weight, quite particularly preferably more than 98% by weight, and in particular 100% by weight of a polyalkylene glycol, preferably polyethylene glycol and/or polypropylene glycol, particularly, however polyethylene glycol. Dispersion agents, which comprise polypropylene glycol in addition to polyethylene glycol, advantageously have a weight proportion ratio of polyethylene glycol to polypropylene glycol between 40:1 and 1:2, preferably between 20:1 and 1:1, particularly preferably between 10:1 and 1.5:1 and in particular between 7:1 and 2:1.

Further preferred dispersion agents are the non-ionic surfactants that are added alone, particularly preferably, however in combination with a non-ionic polymer.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol radical may be linear or, preferably, methyl-branched in the 2-position or may contain linear and methyl-branched radicals in the form of the mixtures typically present in oxoalcohol radicals. Particularly preferred are, however, alcohol ethoxylates with linear radicals of alcohols of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄-alcohols with 3 EO or 4EO, C₉₋₁₁-alcohols with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, as well as mixtures of C₁₂₋₁₄-alcohols with 3 EO and C₁₂₋₁₈-alcohols with 5 EO. The cited degrees of ethoxylation constitute statistical average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

Furthermore, as additional non-ionic surfactants, alkyl glycosides that satisfy the general Formula RO(G)ₓ can be added, where R means a primary linear or methyl-branched, particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 4.0, preferably between 1.2 and 1.4.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (V), 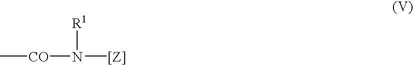
in which RCO stands for an aliphatic acyl radical with 6 to 22 carbon atoms, R¹ for hydrogen, an alkyl or hydroxyalkyl radical with 1 to 4 carbon atoms and [Z] for a linear or branched polyhydroxyalkyl radical with 3 to 10 carbon atoms and 3 to 10 hydroxy groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula 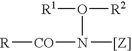
in which R is a linear or branched alkyl or alkenyl radical containing 7 to 12 carbon atoms, R¹ is a linear, branched or cyclic alkyl radical or an aryl radical containing 2 to 8 carbon atoms and R² is a linear, branched or cyclic alkyl radical or an aryl radical or an oxyalkyl radical containing 1 to 8 carbon atoms, C₁₋₄ alkyl or phenyl radicals being preferred, and [Z] is a linear polyhydroxyalkyl radical, of which the alkyl chain is substituted by at least two hydroxy radicals, or alkoxylated, preferably ethoxylated or propoxylated derivatives of that radical.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The preferred surfactants are weakly foaming non-ionic surfactants. The inventive detergents for automatic dishwashers are particularly preferred when they comprise non-ionic surfactants, particularly non-ionic surfactants from the group of alkoxylated alcohols. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol radical may be linear or, preferably, methyl-branched in the 2-position or may contain linear and methyl-branched radicals in the form of the mixtures typically present in oxoalcohol radicals. Particularly preferred are, however, alcohol ethoxylates with linear radicals of alcohols of natural origin with 12 to 18 carbon atoms, e.g. from coco-, palm-, tallow- or oleyl alcohol, and an average of 2 to 8 EO per mol alcohol. Exemplary preferred ethoxylated alcohols include C₁₂₋₁₄-alcohols with 3 EO or 4EO, C₉₋₁₁-alcohols with 8 EO, C₁₃₋₁₅-alcohols with 3 EO, 5EO, 7EO or 8EO, C₁₂₋₁₈-Alcohols with 3EO, 5EO or 7EO and mixtures thereof such as mixtures of C₁₂₋₁₈-alcohols with 3 EO and C₁₂₋₁₈-alcohols with 5 EO. The cited degrees of alkoxylation constitute statistical average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

The inventive agents are particularly preferred when they comprise a non-ionic surfactant that exhibits a melting point above room temperature. Accordingly, preferred dishwasher agents are characterized in that they comprise non-ionic surfactant(s) with a melting point above 20° C., preferably above 25° C., particularly preferably between 25 and 60° C. and, in particular between 26.6 and 43.3° C.

Suitable non-ionic surfactants with a melting and/or softening point in the cited temperature range are, for example weakly foaming non-ionic surfactants that can be solid or highly viscous at room temperature. If non-ionic surfactants are used that are highly viscous at room temperature, they preferably have a viscosity above 20 Pas, particularly preferably above 35 Pas and in particular above 40 Pas. Non-ionic surfactants, which are wax-like in consistency at room temperature, are also preferred.

Preferred non-ionic surfactants that are solid at room temperature are used and belong to the groups of alkoxylated non-ionic surfactants, more particularly ethoxylated primary alcohols, and mixtures of these surfactants with structurally more complex surfactants, such as polyoxypropylene/polyoxyethylene/polyoxypropylene (PO/EO/PO) surfactants. Such (PO/EO/PO) non-ionic surfactants are characterized in addition as having good foam control.

In one preferred embodiment of the present invention, the non-ionic surfactant with a melting point above room temperature is an ethoxylated non-ionic surfactant that results from the reaction of a monohydroxyalkanol or alkylphenol containing 6 to 20 carbon atoms with preferably at least 12 moles, particularly preferably at least 15 moles and in particular at least 20 moles of ethylene oxide per mole of alcohol or alkylphenol.

A particularly preferred non-ionic surfactant that is solid at room temperature is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these non-ionic surfactants, the so-called narrow range ethoxylates (see above) are particularly preferred.

Thus, particularly preferred dishwasher agents according to the invention comprise ethoxylated non-ionic surfactant(s) prepared from C₆₋₂₀-monohydroxy alkanols or C₆₋₂₀-alkyl phenols or C₁₆₋₂₀-fatty alcohols and more than 12 mole, preferably more than 15 mole and in particular more than 20 mole ethylene oxide per mole alcohol.

The non-ionic surfactant, which is solid at room temperature, preferably contains additional propylene oxide units in the molecule. These PO units preferably make up as much as 25% by weight, more preferably as much as 20% by weight and, in particular up to 15% by weight of the total molecular weight of the non-ionic surfactant. Particularly preferred non-ionic surfactants are ethoxylated monohydroxyalkanols or alkylphenols, which have additional polyoxyethylene-polyoxypropylene block copolymer units. The alcohol or alkylphenol component of these non-ionic surfactant molecules preferably makes up more than 30 wt. %, more preferably more than 50 wt. % and most preferably more than 70 wt. % of the total molecular weight of these non-ionic surfactants. Preferred dishwasher agents are characterized in that they comprise ethoxylated and propoxylated non-ionic surfactants, in which the propylene oxide units in the molecule preferably make up as much as 25% by weight, more preferably as much as 20% by weight and, in particular up to 15% by weight of the total molecular weight of the non-ionic surfactant.

Other particularly preferred non-ionic surfactants with melting points above room temperature contain 40 to 70% of a polyoxypropylene/polyoxyethylene/polyoxypropylene block polymer blend that contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylolpropane and containing 24 moles of ethylene oxide and 99 moles of propylene oxide per mole of trimethylolpropane.

Non-ionic surfactants, which may be used with particular advantage are obtainable, for example, under the name of Poly Tergent® SLF-18 from Olin Chemicals.

A further preferred inventive dishwasher agent comprises non-ionic surfactants of Formula (VI)
R¹O[CH₂CH(CH₃)O]ₓ[CH₂CH₂O]_{y}[CH₂CH(OH)R²], (VI)
in which R¹ stands for a linear or branched aliphatic hydrocarbon radical with 4 to 18 carbon atoms or mixtures thereof, R² means a linear or branched hydrocarbon radical with 2 to 26 carbon atoms or mixtures thereof and x stands for values between 0.5 and 1.5 and y stands for a value of at least 15.

Other preferred non-ionic surfactants are the end-capped poly(oxyalkylated) non-ionic surfactants corresponding to the following Formula
R¹O[CH₂CH(R³)O]ₓ[CH₂]kCH(OH)[CH₂]ⱼOR²
in which R¹ and R² stand for linear or branched, saturated or unsaturated, aliphatic or aromatic hydrocarbon radicals with 1 to 30 carbon atoms, R³ stands for H or for a methyl, ethyl, n-propyl, isopropyl, n-butyl, 2-butyl or 2-methyl-2-butyl radical, x stands for values between 1 and 30, k and j for values between 1 and 12, preferably 1 to 5. Each R³ in the above formula can be different for the case where x=2. R¹ and R² are preferably linear or branched, saturated or unsaturated, aliphatic or aromatic hydrocarbon radicals containing 6 to 22 carbon atoms, radicals containing 8 to 18 carbon atoms being particularly preferred. H, —CH₃ or —CH₂CH₃ are particularly preferred for the radical R³. Particularly preferred values for x are in the range from 1 to 20 and more particularly in the range from 6 to 15.

As described above, each R³ in the above formula can be different for the case where x=2. By this means, the alkylene oxide unit in the straight brackets can be varied. If, for example, x has a value of 3, the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to
R¹O[CH₂CH(R³)O]ₓCH₂CH(OH)CH₂OR²
In this last formula, R¹, R² and R³ are as defined above and x stands for a number from 1 to 30, preferably 1 to 20 and in particular 6 to 18. Surfactants in which the substituents R1 and R2 have 9 to 14 carbon atoms, R³ stands for H and x takes a value of 6 to 15 are particularly preferred.

In summary, preferred automatic dishwasher agents are those, which contain end-capped poly (oxyalkylated) non-ionic surfactants corresponding to the formula
R¹O[CH₂CH(R³)O]ₓ[CH₂]ₖCH(OH)[CH₂]ⱼOR²
in which R¹ and R² stand for linear or branched, saturated or unsaturated, aliphatic or aromatic hydrocarbon radicals with 1 to 30 carbon atoms, R³ stands for H or for a methyl, ethyl, n-propyl, isopropyl, n-butyl, 2-butyl or 2-methyl-2-butyl radical, x has a value of 1 to 30, k and j have values of 1 to 12 and preferably 1 to 5, wherein surfactants of the type
R¹O[CH₂CH(R³)O]ₓCH₂CH(OH)CH₂OR²
in which x stands for numbers from 1 to 30, preferably 1 to 20 and in particular 6 to 18, are particularly preferred.

Particularly preferred non-ionic surfactants in the context of the present invention have proved to be weakly foaming non-ionic surfactants, which have alternating ethylene oxide and alkylene oxide units. Among these, the surfactants with EO-AO-EO-AO blocks are again preferred, wherein one to ten EO or AO groups respectively are linked together, before a block of the other groups follows. Inventive automatic dishwasher agents are preferred here, which comprise surfactants of the general formula VII as the non-ionic surfactant(s) 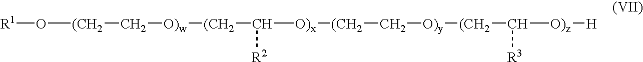
in which R¹ stands for a linear or branched, saturated or mono- or polyunsaturated C₆₋₂₄-alkyl or alkenyl radical, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

The preferred non-ionic surfactants of Formula VII can be manufactured by known methods from the corresponding alcohols R¹—OH and ethylene- or alkylene oxide. The radical R¹ in the previous Formula VII can vary depending on the origin of the alcohol. Should natural sources be used, the radical R¹ has an even number of carbon atoms and generally is not branched, the linear radicals of alcohols of natural origin with 12 to 18 carbon atoms, for example coconut, palm, tallow or oleyl alcohol being preferred. The alcohols available from synthetic sources are, for example Guerbet alcohols or methyl branched in the 2-position or mixtures of linear and methyl branched radicals, as are typically present in oxo alcohols. Independently of the type of alcohol added for the manufacture of the non-ionic surfactants comprised in the agents, inventive automatic dishwasher agents are preferred, wherein R¹ in Formula VII stands for an alkyl radical with 6 to 24, preferably 8 to 20, particularly preferably 9 to 15 and in particular 9 to 11 carbon atoms.

In addition to propylene oxide, in particular butylene oxide can be the alkylene oxide unit that alternates with the ethylene oxide unit in the preferred non-ionic surfactants. However, also other alkylene oxides are suitable, in which R² or R³ independently of one another are selected from —CH₂CH₂—CH₃ or CH(CH₃)₂. Preferred automatic dishwasher agents are those wherein R² or R³ stand for a —CH₃ radical, w and x independently of one another stand for values of 3 or 4 and y and z independently of one another stand for values of 1 or2.

In summary, especially preferred inventive non-ionic surfactants for use in the agents according to the invention are those that have a C₉₋₁₅-alkyl radical with 1 to 4 ethylene oxide units, followed by 1 to 4 propylene oxide units, followed by 1 to 4 ethylene oxide units, followed by 1 to 4 propylene oxide units. These surfactants exhibit the required low viscosity in aqueous solution and according to the invention are used with particular preference.

Other preferred non-ionic surfactants are the end-capped poly(oxyalkylated) non-ionic surfactants corresponding to the following Formula (VIII)
R¹O[CH₂CH(R³)O]ₓR² (VIII)
in which R¹ stands for linear or branched, saturated or unsaturated, aliphatic or aromatic hydrocarbon radicals with 1 to 30 carbon atoms, R² for linear or branched, saturated or unsaturated, aliphatic or aromatic hydrocarbon radicals with 1 to 30 carbon atoms, which preferably contains 1 to 5 hydroxy groups and preferably is also functionalized with an ether group, R³ stands for H or for a methyl, ethyl, n-propyl, isopropyl, n-butyl, 2-butyl or 2-methyl-2-butyl radical, x has a value of 1 to 40

In particularly preferred non-ionic surfactants according to the above Formula (VIII), R³ stands for H. For the resulting end capped polyoxyalkylated non-ionic surfactants of Formula (IX)
R¹O[CH₂CH₂O]ₓR² (IX)
such non-ionic surfactants are particularly preferred, in which R¹ stands for linear or branched, saturated or unsaturated, aliphatic or aromatic hydrocarbon radicals with 1 to 30 carbon atoms, preferably with 4 to 20 carbon atoms, R² for linear or branched, saturated or unsaturated, aliphatic or aromatic hydrocarbon radicals with 1 to 30 carbon atoms, which preferably contains 1 to 5 hydroxy groups and x has a value of 1 to 40

Particularly preferred end capped polyoxyalkylated non-ionic surfactants are those according to Formula (X)
R¹O[CH₂CH₂O]ₓCH₂CH(OH)R² (X)
which in addition to a radical R¹ that stands for linear or branched, saturated or unsaturated, aliphatic or aromatic hydrocarbon radicals with 1 to 30 carbon atoms, preferably 4 to 20 carbon atoms, comprises a linear or branched, saturated or unsaturated, aliphatic or aromatic hydrocarbon radicals with 1 to 30 carbon atoms R²that is neighboring an intermediate group —CH₂CH(OH)—. In this Formula, x stands for a number between 1 and 40. Such end capped polyoxyalkylated non-ionic surfactants can be obtained, for example, by reacting a terminal epoxide of formula R²CH(O)CH₂ with an ethoxylated alcohol of formula
R¹O[CH₂CH₂O]ₓ₋₁CH₂CH₂OH.

The cited carbon chain lengths and the ethoxylation or alkoxylation degrees of the cited non-ionic surfactants constitute statistical median values that can be a whole or a fractional number for a specific product. Due to the manufacturing process, commercial products of the cited formulae do not consist in the main of one sole representative, but rather are a mixture, wherein not only the carbon chain lengths but also the degree of ethoxylation or alkoxylation can be average values and can thus be fractional numbers.

Particularly preferred inventive detergent or cleaning agents are characterized in that at least one dispersion agent is selected from the group of non-ionic surfactants. Particularly preferred inventive detergent or cleaning agents comprise at least one non-ionic surfactant, preferably at least one end capped polyoxyalkylated non-ionic surfactant as the dispersion agent, the proportion by weight of the non-ionic surfactant to the total weight of all dispersion agents being preferably between 1 and 60 wt. %, particularly preferably between 2 and 50 wt. % and in particular between 3 and 40 wt. %. Particularly preferred detergent or cleaning agents according to the invention are those in which the total weight of the non-ionic surfactant(s) to the total weight of the inventive agent ranges from 0.5 to 40 wt. %, preferably between 1 and 30 wt. %, particularly preferably between 2 and 25 wt. % and in particular between 2.5 and 23 wt. %.

Preferred inventive detergent or cleaning agents are characterized in that the dispersion, based on the total weight of the detergent or cleaning agent, comprises at least 30 wt. %, advantageously at least 50 wt. %, preferably at least 60 wt. %, particularly preferably at least 70 wt. %, quite particularly preferably at least 80 wt. % and in particular at least 90 wt. % of the total non-ionic surfactant comprised in the detergent or cleaning agent.

Preferred inventive detergents or cleaning agents are characterized in that at least one dispersion agent has a melting point above 25° C., preferably above 35° C. and particularly preferably above 40° C. Thus, such agents comprise, for example, a dispersion agent with a melting point above 26° C., or above 27° C., or above 28° C., or above 29° C., or above 30° C., or above 31° C., or above 32° C., or above 33° C., or above 34° C., or above 35° C., or above 36° C., or above 37° C., or above 38° C., or above 39° C., or above 40° C., or above 41° C., or above 42° C., or above 43° C., or above 44° C., or above 45° C., or above 46° C., or above 47° C., or above 48° C., or above 49° C., or above 50° C. It is particularly preferred to add dispersion agents having a melting point or a melting range between 30 and 80° C., preferably between 35 and 75° C., particularly preferably between 40 and 70° C., particularly preferably between 45 and 65° C., wherein these dispersion agents have a weight proportion, based on the total weight of the added dispersion agent, above 10 wt. %, particularly above 40 wt. %, particularly preferably above 70 wt. % and in particular between 80 and 100 wt. %.

Preferred inventive detergents and cleaning agents are characterized in that the dispersion is a dimensionally stable material at 20° C. Agents are considered to be dimensionally stable when they have their own dimensional stability that allows them, under normal conditions of manufacture, storage, transport and consumer utilization, to assume a non-disintegrated shape, wherein this shape does not change under the cited conditions, even over a longer period, preferably 4 weeks, particularly preferably 8 weeks and in particular 32 weeks, i.e. that under normal conditions of manufacture, storage, transport and utilization by the customer remains in the spatial and geometric shape defined by their manufacture, i.e. does not deliquesce. In this regard, the dimensionally stable agents include “kneadable” agents, in addition to agents possessing hard surfaces. According to the invention, preferred dispersions are dimensionally stable at temperatures up to 20° C., advantageously up to 25° C., particularly preferably up to 30° C. and in particular up to 35° C.

In a further preferred embodiment, the inventive detergent or cleaning agents comprise at least one dispersion agent having a melting point below 15° C., preferably below 12° C. and particularly preferably below 8° C. Particularly preferred dispersion agents have a melting range between 2 and 14° C., in particular between 4 and 10° C. Based on the total weight of the dispersion agent, the proportion by weight of this low-melting dispersion agent to that of the inventive agent, i.e. the dispersion agents with a melting point below 15° C., is preferably more than 30 wt. %, preferably more than 50 wt. %, particularly preferably between 70 and 100 wt. %, quite particularly preferably between 80 and 98 wt. % and in particular between 88 and 96 wt. %. Inventive agents with a content of such types of low-melting dispersion agents can be capable of flowing. In the context of the present invention, inventive detergents or cleaning agents that are capable of flowing at 20° C. are particularly preferred. Preferred detergents or cleaning agents are characterized in that the dispersion is a liquid (20° C.), preferably a liquid with a viscosity (Brookfield-Viscosimeter LVT-II at 20° C. rpm and 20° C., spindle 3) preferably in the range from 50 to 100 000 mPas, further preferred from 100 to 50 000 mPas, particularly preferred from 200 to 10 000 mPas and in particular from 300 to 5000 mPas.

In the context of the present application, suitable dispersed materials, are all active detergents or cleaning substances that are solid at room temperature, particularly however, active detergent or cleaning substances from the group of builders and co-builders, active detergent and cleaning polymers, bleaching agents, bleach activators, glass corrosion protection agents, silver protection agents and/or enzymes. In the context of the present application, preferred detergents or cleaning agents are accordingly characterized in that at least one of the dispersed materials is selected from the group of builders and co-builders, active detergent and cleaning anionic and/or cationic and/or amphoteric polymers, bleaching agents, bleach activators, silver protection agents, glass corrosion protection agents and/or enzymes.

In the context of the present invention, the builders include especially the zeolites silicates, carbonates, organic co builders and also—where there are no ecological reasons preventing their use—phosphates.

Suitable crystalline, layered sodium silicates correspond to the general formula NaMSiₓO₂ₓ₊₁H₂O, wherein M is sodium or hydrogen, x is a number from 1.9 to 4 and y is a number from 0 to 20, preferred values for x being 2, 3 or 4. Preferred crystalline layered silicates of the given formula are those in which M stands for sodium and x assumes the values 2 or 3. Both β- and δ-sodium disilicates Na₂Si₂O₅.yH₂O are preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6 which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous.” In other words, the silicates do not produce any of the sharp X-ray responses typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and in particular up to at most 20 nm being preferred. This type of X-ray amorphous silicates similarly possesses a delayed dissolution in comparison with the customary water glasses. Compacted/densified amorphous silicates, compounded amorphous silicates and over dried X-ray-amorphous silicates are particularly preferred.

In the context of the present invention, preferred detergents and cleaning agents are characterized in that they comprise silicate(s), preferably alkali silicates, particularly preferably crystalline or amorphous alkali disilicates in quantities of 10 to 60 wt. %, preferably 15 to 50 wt. % and in particular 20 to 40 wt. %, each based on the weight of the detergent or cleaning agent.

When the inventive agents are used as automatic dishwasher agents, then they preferably comprise at least one crystalline layer-forming silicate of the general formula NaMSiₓO₂ₓ₊₁.yH₂O, wherein M represents sodium or hydrogen, x is a number from 1.9 to 22, preferably 1.9 to 4 and y stands for a number from 0 to 33. The crystalline layer-forming silicates of Formula (I) are marketed, for example by Clariant GmbH (Germany) under the trade names Na-SKS, e.g. Na-SKS-1 (Na₂Si₂₂O₄₅.xH₂O, Kenyait), Na-SKS-2 (Na₂Si₁₄O₂₉.xH₂O, Magadiit), Na-SKS-3 (Na₂Si₈O₁₇.xH₂O) or Na-SKS-4 (Na₂Si₄O₉.xH₂O, Makatit).

For the purposes of the present invention, particularly suitable agents comprise crystalline layered silicates of Formula (I), in which x stands for 2. Among these are notably Na-SKS-5 (α-Na₂Si₂O₅), Na-SKS-7 (β-Na₂Si₂O₅, Natrosilit), Na-SKS-9 (NaHSi₂O₅.H₂O), Na-SKS-10 (NaHSi₂O₅.3H₂O, Kanemit), Na-SKS-11 (t-Na₂Si₂O₅) and Na-SKS-13 (NaHSi₂O₅), but particularly Na-SKS-6 (δ-Na₂Si₂O₅). A review of crystalline layered silicates is found in the published article in “Seifen-Öle-Fette-Wachse, 116, Nr. 20/1990” on pages 805-808.

In the context of the present invention, preferred automatic dishwasher agents or auxiliaries for automatic dishwasher agents possess a content by weight of crystalline layered silicates of formula (I) from 0.1 to 20 wt. %, preferably 0.2 to 15 wt. % and in particular 0.4 to 10 wt. %, each based on the total weight of the agent. Particularly preferred are especially those automatic dishwasher agents, which have a total silicate content below 7 wt. %, preferably below 6 wt. %, preferably below 5 wt. %, particularly preferably below 4 wt. %, quite particularly preferably below 3 wt. % and in particular below 2.5 wt. %, wherein this silicate, based on the total weight of the comprised silicate is preferably at least 70 wt. %, preferably at least 80 wt. % and in particular at least 90 wt. % of a silicate of the general formula NaMSiₓO₂ₓ₊₁.yH₂O.

Of the suitable fine crystalline, synthetic zeolites containing bound water, zeolite A and/or P are preferred. A particularly preferred zeolite P is zeolite MAP® (a commercial product of Crosfield). However, the zeolites X as well as mixtures of A, X and/or P are also suitable. Commercially available and preferred in the context of the present invention is, for example, also a co-crystallizate of zeolite X and zeolite A (ca. 80 wt. % zeolite X), which is marketed under the name of VEGOBOND Ax® by Condea Augusta S.p.A. and which can be described by the Formula
nNa₂O(1-n)K₂OAl₂O₃(2-2.5)SiO₂(3.5-5.5)H₂O
The zeolite can be added both as the builder in a granular compound as well as being used as a type of “powdering” of the total mixture being pressed, wherein normally, both ways are used to incorporate the zeolite in the premix. Suitable zeolites have a mean particle size of less than 10 μm (volume distribution, as measured by the Coulter Counter Method) and contain preferably 18 to 22% by weight and in particular 20 to 22% by weight of bound water.

Naturally, the generally known phosphates can also be added as builders, in so far that their use should not be avoided on ecological grounds. This is particularly true for the addition of inventive agents as automatic dishwasher agents, which is particularly preferred in the context of the present application. In the washing and cleaning agent industry, among the many commercially available phosphates, the alkali metal phosphates are the most important and pentasodium or pentapotassium triphosphates (sodium or potassium tripolyphosphate) are particularly preferred.

Alkali metal phosphates is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits on machine parts and lime incrustations in fabrics and, in addition, contribute in this way towards the cleaning power.

Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H₂P₂O₇) and, at higher temperatures into sodium trimetaphosphate (Na₃P₃O₉) and Maddrell's salt (see below). NaH₂PO₄ shows an acidic reaction. It is formed by adjusting phosphoric acid with sodium hydroxide to a pH value of 4.5 and spraying the resulting “mash.” Potassium dihydrogen phosphate (primary or monobasic potassium phosphate, potassium biphosphate, KDP), KH₂PO₄, is a white salt with a density of 2.33 gcm⁻³, has a melting point of 253° C. [decomposition with formation of potassium polyphosphate (KPO₃)ₓ] and is readily soluble in water.

Disodium hydrogen phosphate (secondary sodium phosphate), Na₂HPO₄, is a colorless, readily water-soluble crystalline salt. It exists in anhydrous form and with 2 mol (density 2.066 gcm⁻³, water loss at 95° C.), 7 mol (density 1.68 gcm-3, melting point 48° with loss of 5 H₂O) and 12 mol of water (density 1.52 gcm⁻³, melting point 35° with loss of 5 H₂O), becomes anhydrous at 100° and, on fairly intensive heating, is converted into the diphosphate Na₄P₂O₇. Disodium hydrogen phosphate is prepared by neutralization of phosphoric acid with soda solution using phenolphthalein as indicator. Dipotassium hydrogen phosphate (secondary or dibasic potassium phosphate), K₂HPO₄, is an amorphous white salt, which is readily soluble in water.

Trisodium phosphate, tertiary sodium phosphate, Na₃PO₄, consists of colorless crystals, which as dodecahydrate have a density of 1.62 gcm⁻³ and a melting point of 73-76° C. (decomposition), as the decahydrate (corresponding to 19-20% P₂O₅), a melting point of 100° C. and in anhydrous form (corresponding to 39-40% P₂O₅) a density of 2.536 gcm⁻³. Trisodium phosphate is easily soluble in water undergoing an alkaline reaction and is manufactured by evaporation of a solution of exactly 1 mole disodium phosphate and 1 mole NaOH. Tripotassium phosphate (tertiary or tribasic potassium phosphate) K₃PO₄, is a white, deliquescent, granular powder, density 2.56 gcm⁻³, with a melting point of 1340° C. and is easily soluble in water, undergoing an alkaline reaction. It is synthesized e.g. by heating basic slag with coal and potassium sulfate. Despite their higher price, the more readily soluble and therefore highly effective potassium phosphates are often preferred to corresponding sodium compounds in the detergent industry.

Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm⁻³, melting point 94° C. with loss of water). Both substances are colorless crystals, which dissolve in water through an alkaline reaction. Na₄P₂O₇ is formed when disodium phosphate is heated to more than 200° C. or by reacting phosphoric acid with soda in a stoichiometric ratio and spray drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, which is soluble in water, the pH of a 1% solution at 25° C. being 10.4.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types in particular are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is anhydrous or crystallizes with 6H₂O to a non-hygroscopic white water-soluble salt which and which has the general formula NaO—[P(O)(ONa)—O]ₙ—Na where n=3. Around 17 g of the salt free from water of crystallization dissolve in 100 g of water at room temperature, around 20 g at 60° C. and around 32 g at 100° C. After heating the solution for 2 hours to 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray-dried. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is marketed for example in the form of a 50% by weight solution (>23% P₂O₅, 25% K₂O). The potassium polyphosphates are widely used in the detergent industry. Sodium potassium tripolyphosphates, which may also be used in accordance with the present invention, also exist. They are formed for example when sodium trimetaphosphate is hydrolyzed with KOH:
(NaPO₃)₃+2KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

In the context of the present invention, preferred agents are characterized in that they comprise phosphate(s), preferably alkali metal phosphate(s), particularly preferably pentasodium or pentapotassium triphosphate (sodium or potassium triphosphate) in quantities of 5 to 80 wt. %, preferably 15 to 75 wt. % and in particular 20 to 70 wt. %, each based on the weight of the detergent or cleaning agent.

Particularly preferred are especially those inventive agents, in which the proportion by weight of the potassium tripolyphosphate to sodium tripolyphosphate is greater than 1:1, preferably greater than 2:1, more preferably greater than 5:1, particularly preferably greater than 10:1 and in particular greater than 20:1. Inventive dispersions are particularly preferred, which comprise only potassium tripolyphosphate

Additional components can be alkaline entities. Alkali metal hydroxides, alkali metal carbonates, alkali metal hydrogen carbonates, alkali metal sesquicarbonates, alkali silicates, alkali metal silicates and mixtures of the cited materials can be used as alkaline entities, whereby in the context of this invention, the alkali carbonates are preferably used, in particular sodium carbonate, sodium hydrogen carbonate or sodium sesquicarbonate. A builder system comprising a mixture of tripolyphosphate and sodium carbonate is particularly preferred. A builder system comprising a mixture of tripolyphosphate and sodium carbonate and sodium disilicate is also particularly preferred.

Particularly preferred detergents and cleaning agents comprise carbonate(s) and/or hydrogen carbonate(s), preferably alkali carbonates, particularly preferably sodium carbonate in quantities of 2 to 50 wt. %, preferably 5 to 40 wt. % and in particular 7.5 to 30 wt. %, each based on the weight of the detergent or cleaning agent.

Organic co builders, which may be used in the detergents and cleaning agents according to the invention, include, in particular, polycarboxylates or polycarboxylic acids, polymeric polycarboxylates, aspartic acid, polyacetals, dextrins, other organic co builders (see below) and phosphonates. These classes of substances are described in the following.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of polycarboxylic acids such as citric acid, adipic acid, succinic acid, glutaric acid, tartaric acid, sugar acids and mixtures thereof.

Acids per se can also be used. Besides their building effect, the acids also typically have the property of an acidifying component and, hence also serve to establish a relatively low and mild pH in detergents or cleaning agents. Citric acid, succinic acid, glutaric acid, adipic acid, gluconic acid and mixtures thereof are particularly mentioned in this regard.

Other suitable builders are polymeric polycarboxylates, i.e. for example the alkali metal salts of polyacrylic or polymethacrylic acid, for example those with a relative molecular weight of 500 to 70 000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates, which preferably have a molecular weight of 2000 to 20 000 g/mol. By virtue of their superior solubility, preferred representatives of this group are the short-chain polyacrylates, which have molecular weights of 2000 to 10 000 g/mol and, more particularly, 3000 to 5000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2000 to 70 000 g/mol, preferably 20 000 to 50 000 g/mol and in particular 30 000 to 40 000 g/mol.

The (co)polymeric polycarboxylates may be used either in powder form or in the form of an aqueous solution. The content of (co)polymeric polycarboxylates in the detergents is preferably 0.5 to 20% by weight and more particularly 3 to 10% by weight.

In order to improve the water solubility, the polymers can also comprise allylsulfonic acids as monomers, such as for example, allyloxybenzene sulfonic acid and methallylsulfonic acid.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Other preferred copolymers are those, which preferably contain acrolein and acrylic acid/acrylic acid salts or acrolein and vinyl acetate as monomers.

Similarly, other preferred builders are polymeric aminodicarboxylic acids, salts or precursors thereof. Polyaspartic acids or salts and derivatives thereof are particularly preferred.

Other suitable builders are polyacetals, which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Further suitable organic builders are dextrins, for example oligomers or polymers of carbohydrates, which may be obtained by partial hydrolysis of starches. The hydrolysis may be carried out by standard methods, for example acid- or enzyme-catalyzed methods. The end products are preferably hydrolysis products with average molecular weights of 400 to 500 000 g/mol. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose syrups with a DE of 20 to 37 and also so-called yellow dextrins and white dextrins with relatively high molecular weights of 2000 to 30 000 g/mol may be used.

The oxidized derivatives of such dextrins are their reaction products with oxidizing agents that are capable of oxidizing at least one alcohol function of the saccharide ring to the carboxylic acid function.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups.

Another class of substances with co-builder properties are the phosphonates, more particularly hydroxyalkane and aminoalkane phosphonates. Among the hydroxyalkane phosphonates, 1-hydroxyethane-1,1-diphosphonate (HEDP) is a particularly important co-builder. It is preferably used in the form of the sodium salt, the disodium salt showing a neutral reaction and the tetrasodium salt an alkaline reaction (pH 9). Preferred aminoalkane phosphonates are ethylenediamine tetramethylene phosphonate (EDTMP), diethylenetriamine pentamethylene phosphonate (DTPMP) and higher homologs thereof. They are preferably used in the form of the neutrally reacting sodium salts, for example as the hexasodium salt of EDTMP or as the hepta- and octasodium salts of DTPMP. Of the phosphonates, HEDP is preferably used as a builder. In addition, the aminoalkane phosphonates have a pronounced heavy metal binding capacity. Accordingly, it can be of advantage, particularly where the agents also contain bleach, to use aminoalkane phosphonates, more particularly DTPMP, or mixtures of the phosphonates mentioned.

In addition, any compounds capable of forming complexes with alkaline earth metal ions may be used as co-builders.

Inventive detergents or cleaning agent compositions may additionally comprise active detergent or cleaning polymers as the dispersed materials. The group of these polymers includes, for example, the rinsing polymers and/or polymers active for water softening.

Exemplary polymers active for water softening are polymers with sulfonic acid groups, which are particularly preferred for use in the inventive agents.

Particularly preferred suitable polymers comprising sulfonic acid groups are copolymers of unsaturated carboxylic acids, monomers comprising sulfonic acid groups and optional further ionic or non-ionogenic monomers.

In the context of the present invention, unsaturated carboxylic acids of Formula XI are preferred monomers,
R¹(R²)C═C(R³)COOH (XI),
in which R¹ to R³ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms.

Among the unsaturated carboxylic acids corresponding to Formula XI, acrylic acid (R¹═R²═R³═H), methacrylic acid (R¹═R²═H; R³═CH₃) and/or maleic acid (R¹═COOH; R²═R³═H) are particularly preferred.

The preferred monomers containing sulfonic acid groups correspond to those of the Formula XII,
R⁵(R⁶)C═C(R⁷)—X—SO₃H (XII),
in which R⁵ to R⁷ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Among these monomers, those corresponding to Formulae XIIa, XIIb and/or XIIc are preferred,
H₂C═CH—X—SO₃H (XIIa),
H₂C═C(CH₃)—X—SO₃H (XIIb),
HO₃S—X—(R⁶)C═C(R⁷)—X—SO₃H (XIIc),
in which R⁶ and R⁷ independently of one another are selected from —H, —CH₃, —CH₂CH₃, —CH₂CH₂CH₃, —CH(CH₃)₂ and X is an optionally present spacer group selected from —CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X═—C(O)NH—CH(CH₂CH₃) in formula (XIIa)), 2-acrylamido-2-propanesulfonic acid (X═—C(O)NH—C(CH₃)₂ in formula (XIIa)), 2-acrylamido-2-methyl-1-propanesulfonic acid (X═—C(O)NH—CH(CH₃)CH₂— in formula (XIIa)), 2-methacrylamido-2-methyl-1-propanesulfonic acid (X═—C(O)NH—H(CH₃)CH₂— in formula (XIIb)), 3-methacrylamido-2-hydroxypropanesulfonic acid (X═—C(O)NH—CH₂OH(OH)CH₂— in formula (XIIb)), allyl sulfonic acid (X═CH₂ in formula (XIIa)), methallylsulfonic acid (X═CH₂ in formula (XIIb)), allyloxybenzenesulfonic acid (X═—CH₂—O—C₆H₄— in formula (XIIa)), methallyloxybenzenesulfonic acid (X═—CH2-O—C₆H₄— in formula (XIIb)), 2-hydroxy-3-(2-propenyloxy)-propanesulfonic acid, 2-methyl-2-propene-1-sulfonic acid (X═CH₂ in formula (XIIb)), styrenesulfonic acid (X═C₆H₄ in formula (XIIa)), vinylsulfonic acid (X not present in formula (XIIa)), 3-sulfopropyl acrylate (X═—C(O)NH—CH₂CH₂CH₂— in formula (XIIa)), 3-sulfopropyl methacrylate (X═—C(O)NH—CH₂CH₂CH₂— in formula (XIIb)), sulfomethacrylamide (X═—C(O)NH— in formula (XIIb)), sulfomethylmethacrylamide (X═—C(O)NH—CH₂— in formula (XIIb)) and water-soluble salts of the acids mentioned.

Additional ionic or non-ionogenic monomers are particularly ethylenically unsaturated compounds. The polymers used in accordance with the invention preferably contain less than 20% by weight, based on polymer, of monomers belonging to group iii). Particularly preferred polymers for use consist solely of monomers belonging to groups i) and ii).

In summary, copolymers of

i) unsaturated carboxylic acids of Formula XI
R¹(R²)C═C(R³)COOH (XI),
in which R¹ to R³ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms,
ii) monomers containing sulfonic acid groups corresponding to Formula XII
   R⁵(R⁶)C═C(R⁷)—X—SO₃H (XII),
   in which R⁵ to R⁷ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms and X stands for an optionally present spacer group, selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or non-ionic monomers.
   are preferred ingredients of the inventive detergents or cleaning agent compositions.

Particularly preferred copolymers consist of
i) one or several unsaturated carboxylic acids from the group acrylic acid, methacrylic acid and/or maleic acid
ii) one or several monomers containing sulfonic acid groups corresponding to Formulae XIIa, XIIb and/or XIIc:
   H₂C═CH—X—SO₃H (XIIa),
   H₂C═C(CH₃)—X—SO₃H (XIIb),
   HO₃S—X—(R⁶)C═C(R⁷)—X—SO₃H (XIIc),
   in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or non-ionic monomers.

The copolymers can contain monomers from groups (i) and (ii) and optionally (iii) in varying amounts, wherein all representatives of group (i) can be combined with all representatives of group (ii) and all representatives of group (iii). Particularly preferred polymers have defined structural units, which are described below.

Thus, for example, inventive detergent or cleaning agent compositions are preferred that are characterized in that they comprise one or more copolymers that comprise structural units of the Formula XIII
—[CH₂—CHCOOH]ₘ—[CH2-CHC(O)—Y—SO₃H]ₚ— (XIII),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)n- with n=0 to 4, for —O—(C₆H₄)—, for —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, another polymer is obtained which is also preferably used in the inventive detergents or cleaning agent compositions and which is characterized in that detergents or cleaning agent compositions comprise one or more copolymers that contain structural units corresponding to formula XIV
—[CH₂—C(CH₃)COOH]ₘ—[CH2-CHC(O)—Y—SO₃H]ₚ— (XIV),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Thus, inventive detergents or cleaning agent compositions, which comprise one or several copolymers that comprise structural units corresponding to Formula XV,
—[CH₂—CHCOOH]ₘ—[CH₂—C(CH₃)C(O)—Y—SO₃H]ₚ— (XV),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred, are also a preferred embodiment of the present invention, exactly as detergents or cleaning agent compositions are also preferred that are characterized in that they comprise one or several copolymers that comprise structural units of Formula XVI,
—[CH₂—C(CH₃)COOH]ₘ—[CH₂—C(CH₃)C(O)—Y—SO₃H]ₚ— (XVI),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred.

Maleic acid may also be used as a particularly preferred group i) monomer instead of or in addition to acrylic acid and/or methacrylic acid. In this way, it is possible to arrive at preferred detergents or cleaning agent compositions, which are characterized in that they comprise one or more copolymers that comprise structural units corresponding to the Formula XVII,
—[HOOCCH—CHCOOH]ₘ—[CH₂—CHC(O)—Y—SO₃H]ₚ— (XVII),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred, and to detergents or cleaning agent compositions that are characterized in that they comprise one or several copolymers that comprise structural units corresponding to Formula XVIII,
—[HOOCCH—CHCOOH]ₘ—[CH₂—C(CH₃)C(O)O—Y—SO₃H]ₚ— (XVIII),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred.

In summary, inventive detergents or cleaning agent compositions are preferred, which comprise one or several copolymers that comprise structural units of Formulae XIII and/or XIV and/or XV and/or XVI and/or XVII and/or XVIII,
—[CH₂—CHCOOH]ₘ—[CH₂—CHC(O)—Y—SO₃H]ₚ— (XIII),
—[CH₂—C(CH₃)COOH]ₘ—[CH₂—CHC(O)—Y—SO₃H]ₚ— (XIV),
—[CH₂—CHCOOH]ₘ—[CH₂—C(CH₃)C(O)—Y—SO₃H]ₚ— (XV),
—[CH₂—C(CH₃)COOH]ₘ—[CH₂—C(CH₃)C(O)—Y—SO₃H]ₚ (XVI),
—[HOOCCH—CHCOOH]ₘ—[CH₂—CHC(O)Y—SO₃H]ₚ— (XVII),
—[HOOCCH—CHCOOH]ₘ—[CH₂—C(CH₃)C(O)O—Y—SO₃H]ₚ— (XVIII),
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, for —O—(C₆H₄)—, for —NH—C(CH₃)₂— or —NH—CH(CH₂CH₃)— are preferred.

The sulfonic acid groups may be present in the polymers completely or partly in neutralized form, i.e. the acidic hydrogen atom of the sulfonic acid groups can be replaced by metal ions, preferably alkali metal ions and more particularly sodium ions, in some or all of the sulfonic acid groups. Corresponding detergents or cleaning agent compositions, which are characterized in that the sulfonic acid groups in the copolymer are present in partly or fully neutralized form are preferred according to the invention.

The monomer distribution of the copolymers used in the inventive detergents or cleaning agent compositions ranges for copolymers that comprise only monomers defined in groups (i) and (ii) from preferably 5 to 95 wt. % (i) and (ii) respectively, particularly preferably 50 to 90 wt. % monomer from group (i) and 10 to 50 wt. % monomer from group (ii) respectively, based on the polymer.

Particularly preferred terpolymers are those that comprise 20 to 85 wt. % monomer from group (i), 10 to 60 wt. % monomer from group (ii) and 5 to 30 wt. % monomer from group (iii).

The molecular weight of the above-mentioned sulfo-copolymers used in the inventive detergents or cleaning agent compositions can be varied to adapt the properties of the polymer to the desired application requirement. Preferred detergents or cleaning agent compositions are characterized in that the molecular weights of the copolymers are 2000 to 200 000 gmol⁻¹, preferably 4000 to 25 000 gmol⁻¹ and in particular 5000 to 15 000 gmol⁻¹.

Preferred inventive agents that are used as automatic dishwasher agents can comprise additional amphoteric or cationic polymers as dispersed materials to improve the rinsing results. These particularly preferred polymers are characterized in that they have at least one positive charge. These types of polymers are preferably water-soluble or water-dispersible, i.e. their solubility in water at 25° C. is above 10 mg/ml.

Particularly preferred cationic or amphoteric polymers comprise at least one ethylenically unsaturated monomer unit of the general Formula
R¹(R²)C═C(R³)R⁴
in which R¹ to R⁴ independently of one another stand for —H, —CH₃, a linear or branched, saturated alkyl radical containing 2 to 12 carbon atoms, a linear or branched, mono- or polyunsaturated alkenyl radical containing 2 to 12 carbon atoms, with —NH₂, —OH or —COOH substituted alkyl or alkenyl radicals as defined above, a heteroatomic group with at least one positively charged group, a quaternized nitrogen atom or at least one amine group with a positive charge between pH 2 and 11 or for —COOH or —COOR⁵, wherein R⁵ is a saturated or unsaturated, linear or branched hydrocarbon radical containing 1 to 12 carbon atoms.

Exemplary cited (unpolymerized) monomer units are diallylamine, methyidiallylamine, dimethyldimethylammonium salts, acrylamidopropyl(trimethyl)ammonium salts (R¹, R², and R³, ═H, R⁴═C(O)NH(CH₂)₂N⁺(CH₃)₃X⁻), methacrylamidopropyl(trimethyl)ammonium salts (R¹ and R²═H, R³═CH₃H, R⁴═C(O)NH(CH₂)₂N⁺(CH₃)₃X⁻).

Particularly preferred constituents of the amphoteric polymers are unsaturated carboxylic acids of the general Formula
R¹(R²)C═C(R³)COOH
in which R¹ to R³ independently of one another stand for —H, —CH₃, a linear or branched, saturated alkyl radical containing 2 to 12 carbon atoms, a linear or branched, mono- or polyunsaturated alkenyl radical containing 2 to 12 carbon atoms, with —NH₂, —OH or —COOH substituted alkyl or alkenyl radicals as defined above or —COOH or —COOR⁴, wherein R⁴ is a saturated or unsaturated, linear or branched hydrocarbon radical containing 1 to 12 carbon atoms.

Particularly preferred amphoteric polymers comprise monomer units derived from diallylamine, particularly dimethyldiallylammonium salts and/or methacrylamidopropyl (trimethyl)-ammonium salts, preferably in the form of chlorides, bromides, iodides, hydroxides, phosphates, sulfates, hydrogen sulfates, ethyl sulfates, methyl sulfates, mesylates, tosylates, formates or acetates in combination with monomer units from the group of ethylenically unsaturated carboxylic acids.

In the context of the present application, preferred detergents or cleaning agents are characterized in that the dispersed materials, based on the total weight of the detergent or cleaning agent, comprise at least 30 wt. %, advantageously at least 50 wt. %, preferably at least 60 wt. %, particularly preferably at least 70 wt. %, quite particularly preferably at least 80 wt. % and in particular at least 90 wt. % of the total anionic and/or cationic and/or amphoteric polymers comprised in the detergent or cleaning agent.

The inventive dispersions may additionally comprise bleaching agents as the dispersed materials. Among the compounds yielding H₂O₂ in water, which serve as bleaching agents, sodium perborate tetrahydrate and sodium perborate monohydrate are particularly important. Other useful bleaching agents are, for example, sodium percarbonate, peroxypyrophosphates, citrate perhydrates and H₂O₂-yielding peracidic salts or peracids, such as perbenzoates, peroxophthalates, diperazelaic acid, phthaloiminoperacid or diperdodecanedioic acid. Detergents according to the invention may also contain bleaching agents from the group of organic bleaching agents. Typical organic bleaching agents are diacyl peroxides, such as dibenzoyl peroxide for example. Other typical organic bleaching agents are the peroxy acids, of which alkyl peroxy acids and aryl peroxy acids are particularly mentioned as examples. Preferred representatives are (a) peroxybenzoic acid and ring-substituted derivatives thereof, such as alkyl peroxybenzoic acids, but also peroxy a-naphthoic acid and magnesium monoperphthalate, b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid and N-nonenylamido persuccinates and c) aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic acid).

Other suitable bleaching agents in the detergents according to the invention are chlorine- and bromine-releasing substances. Suitable chlorine- or bromine-releasing materials are, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

Preferred dispersions comprise bleaching agents in quantities from 1 to 40 wt. %, preferably from 2.5 to 30 wt. % and in particular from 5 to 20 wt. %, each based on the total dispersion.

When the inventive agents are used as automatic dishwasher agents, then they can also comprise bleach activators as dispersed materials in order to achieve an improved bleaching action on cleaning at temperatures of 60° C. and below. Bleach activators, which can be used are compounds which, under perhydrolysis conditions, produce aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In the context of the present application, further preferred added bleach activators are compounds from the group of cationic nitriles, particularly cationic nitriles of the Formula 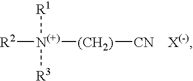
in which R¹ stands for —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group or for an alkyl or alkenylaryl radical having a C₁₋₂₄ alkyl group and at least a further substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 3 or 4 and X is an anion.

In particularly preferred agents according to the invention, there is a cationic nitrile of the Formula 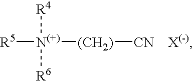
comprised, in which R⁴, R⁵ and R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵═R⁶═—CH₃ and in particular R⁴═R⁵═R⁶═—CH₃, and compounds of the formulae (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preffered, wherein from the group of these substances, the cationic nitrile of formula (CH₃)₃N⁽⁺⁾CH₂—CN X⁻ is particularly preferred, in which X⁻ stands for an anion that is selected from the group chloride, bromide, iodide, hydrogen sulfate, methosulfate, p-toluene sulfate (tosylate) or xylene sulfonate.

Bleach activators, which can be used are also compounds which, under perhydrolysis conditions, produce aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran, N-methyl morpholinium acetonitrile methyl sulfate (MMA), acetylated sorbitol and mannitol and the mixtures thereof (SORMAN), acylated sugar derivatives, more particularly pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam. Substituted hydrophilic acyl acetals and acyl lactams are also preferably used. Combinations of conventional bleach activators may also be used. The bleach activators are usually added in automatic dishwasher agents in quantities from 0.1 to 20 wt. %, preferably from 0.25 to 15 wt. % and in particular from 1 to 10 wt. %, each based on the agent. In the context of the present invention, the cited quantities refer to the weight of the agent without the water-soluble or water-dispersible container.

In addition to the conventional bleach activators, or instead of them, so-called bleach catalysts may also be incorporated into the inventive agents. These substances are bleach-boosting transition metal salts or transition metal complexes, such as, for example, Mn—, Fe—, Co—, Ru— or Mo-salt complexes or -carbonyl complexes. Mn—, Fe—, Co—, Ru—, Mo—, Ti—, V— and Cu-complexes with N-containing tripod ligands, and Co—, Fe—, Cu— and Ru-amine complexes can also be used as bleach catalysts.

Bleach activators from the group of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or isononanoyl-oxybenzenesulfonate (n- or iso-NOBS), n-methyl morpholinium acetonitrile methyl sulfate (MMA) are preferably used, preferably in quantities of up to 10% by weight, in particular in quantities of 0.1% by weight to 8% by weight, particularly 2 to 8% by weight and, particularly preferably 2 to 6% by weight, based on the total weight of the dispersion.

Bleach-boosting transition metal complexes, more particularly containing the central atoms Mn, Fe, Co, Cu, Mo, V, Ti and/or Ru, preferably selected from the group of manganese and/or cobalt salts and/or complexes, particularly preferably the cobalt(amine) complexes, cobalt (acetate) complexes, cobalt (carbonyl) complexes, chlorides of cobalt or manganese and manganese sulfate, are also present in typical quantities, preferably in a quantity of up to 5% by weight, in particular in a quantity of 0.0025% by weight to 1% by weight and particularly preferably in a quantity of 0.01% by weight to 0.25% by weight, each based on the agent as a whole. In special cases, however, even more bleach activator may be used.

A further important criterion for rating an automatic dishwasher agent in addition to its cleaning performance is the optical appearance of the dried crockery after successful cleaning. Possible calcium carbonate deposits on dishes or in the inner chamber of the machine can, for example, can impair customer satisfaction and thus have a causal influence on the economic success of this type of cleaning agent. A further long-standing problem with automatic dishwasher agent is the corrosion of glassware, which results in the occurrence of smears, streaks and scratches as well as iridescence on the glass surface. The observed effects are mainly based on two processes—the migration of alkali and earth alkali ions out of the glass, in conjunction with a hydrolysis of the silicate lattice, and secondly in a deposition of silicate compounds onto the surface of the glass. The cited problem can be solved with the inventive dispersions, if, in addition to the above-mentioned required and optional ingredients, specific glass-corrosion inhibitors are incorporated in the agent. Preferred inventive agents therefore further comprise glass corrosion inhibitors as dispersed material, preferably from the group of magnesium and/or zinc salts and/or magnesium and/or zinc complexes.

A preferred class of compounds that can be added to the inventive agents to prevent glass corrosion are insoluble zinc salts. During the dishwasher cycle, they can attach themselves to the surface of the glass and prevent the dissolution of metal ions from the glass lattice as well as hydrolysis of the silicates. In addition, the insoluble zinc salts also prevent silicate deposits onto the glass surface and thus protect the glass from the above-mentioned consequences.

In terms of the preferred embodiment, insoluble zinc salts are zinc salts with a solubility of maximum 10 grams zinc salt per liter of water at 20° C. According to the invention, examples of particularly preferred insoluble zinc salts are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The cited zinc compounds are preferably used in the inventive agents in quantities that produce an amount of zinc ions in the agent between 0.02 and 10 wt. %, preferably between 0.1 and 5.0 wt. % and in particular between 0.2 and 1.0 wt. %, each based on the agent. The exact content of the zinc salt or zinc salts in the agent naturally depends on the type of zinc salt—the lower the solubility of the added zinc salt, the higher must be its concentration in the inventive agents.

As for the most part the insoluble zinc salts remain unchanged during the dishwasher process, the particle size of the salts is an important criteria for the salts not to stick to the glasswares or machine parts. Inventive, liquid, aqueous automatic dishwasher agents are preferred, in which the insoluble zinc salts have a particle size below 1.7 mm.

When the maximum particle size of the insoluble zinc salt lies below 1.7 mm, one need not worry about insoluble residues in the dishwasher. Preferably, in order to further minimise the danger of insoluble residues, the insoluble zinc salt has an average particle size that lies markedly below this value, for example an average particle size of less than 250 μm. This is more and more true as the solubility of the zinc salt decreases. In addition, the efficiency of the glass corrosion inhibition increases with decreasing particle size. For zinc salts with very low solubility, the particle size preferably lies below 100 μm. For zinc salts with even lower solubility, it can be even less; for example the average particle size for the very poorly soluble zinc oxide preferably lies below 100 μm.

A further preferred class of compounds are magnesium and/or zinc salt(s) of at least one monomeric and/or polymeric organic acid. These ensure that even on repeated use, the surfaces of the glassware are not corroded, in particular that no smears, streaks and scratches or iridescence occur on the glass surfaces.

Although according to the invention, any magnesium and/or zinc salt(s) of monomeric and/or polymeric organic acids can be comprised in the claimed agents, the magnesium and/or zinc salt(s) of monomeric and/or polymeric organic acids from the groups of the non-branched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxoacids, the amino acids and/or the polymeric carboxylic acids are, however, as described above, preferred. In this group, in the context of the present invention, the following cited acids are again preferred:

From the group of unbranched, saturated or unsaturated monocarboxylic acids: methanoic acid (formic acid), ethanoic acid (acetic acid), propanoic acid (propionic acid), pentanoic acid (valeric acid), hexanoic acid (capronic acid), heptanoic acid (enanthic acid), octanoic acid (caprylic acid), nonanoic acid (pelargonic acid), decanoic acid (caprinic acid), undecanoic acid, dodecanoic acid (lauric acid), tridecanoic acid, tetradecanoic acid (myristinic acid), pentadecanoic acid, hexadecanoic acid (palmitinic acid), heptadecanoic acid (margaric acid), octadecanoic acid (stearic acid), eicosanoic acid (arachinic acid), docosanoic acid (behenic acid), tetracosanoic acid (lignocerinic acid), hexacosanoic acid (cerotinic acid), triacotanoic acid (melissinic acid), 9c-hexadecenoic acid (palmitoleinic acid), 6c-octadecenoic acid (petroselinic acid), 6t-octadecenoic acid (petroselaidinic acid), 9c-octadecenoic acid (oleic acid), 9t-octadecenoic acid (elaidinic acid), 9c,12c-octadecadienoic acid (linoleic acid), 9t,12t-octadecadienoic acid (linolaidinic acid) and 9c,12c,15c-octadecatrienoic acid (linolenic acid).

From the group of branched, saturated or unsaturated monocarboxylic acids: 2-methylpentanoic acid, 2-ethylhexanoic acid, 2-propylheptanoic acid, 2-butyloctanoic acid, 2-pentylnonanoic acid, 2-hexyldecanoic acid, 2-heptylundecanoic acid, 2-octyldodecanoic acid, 2-nonyltridecanoic acid, 2-decyltetradecanoic acid, 2-undecylpentadecanoic acid, 2-dodecylhexadecanoic acid, 2-tridecyiheptadecanoic acid, 2-tetradecyloctadecanoic acid, 2-pentadecylnonadecanoic acid, 2-hexadecyleicosanoic acid, 2-heptadecylheneicosanoic acid.

From the group of unbranched, saturated or unsaturated di- or tricarboxylic acids: propanedioic acid (malonic acid), butanedioic acid (succinic acid), pentanedioic acid (glutaric acid), hexanedioic acid (adipic acid), heptanedioic acid (pimelic acid), octanedioic acid (cork acid), nonanedioic acid (azelaic acid), decanedioic acid (sebacic acid), 2c-butenedioic acid (maleic acid), 2t-butendioic acid (fumaric acid), but-2-ynedicarboxylic acid (acetylenedicarboxylic acid).

From the group of aromatic mono-, di- and tricarboxylic acids: benzoic acid, 2-carboxybenzoic acid (phthalic acid), 3-carboxybenzoic acid (isophthalic acid), 4-carboxy-benzoic acid (terephthalic acid), 3,4-dicarboxybenzoic acid (trimellitic acid), 3,5-dicarboxybenzoic acid (trimesic acid).

From the group of sugar acids: galactic acid, mannosaccharic acid, fructic acid, arabinic acid, xylic acid, ribic acid, 2-desoxyribic acid, alginic acid.

From the group of hydroxyacids: hydroxyphenylacetic acid (mandelic acid), 2-hydroxypropionic acid (lactic acid), hydroxysuccinic acid (malic acid), 2,3-dihydroxybutanedioic acid (tartaric acid), 2-hydroxy-1,2,3-propanetricarboxylic acid (citric acid), ascorbic acid, 2-hydroxybenzoic acid (salicylic acid), 3,4,5-trihydroxybenzoic acid (gallic acid).

From the group of oxoacids: 2-oxopropionic acid (pyruvic acid), 4-oxopentanoic acid (levulinic acid).

From the group of amino acids: alanine, valine, leucine, isoleucine, proline, tryptophan, phenylalanine, methionine, glycine, serine, tyrosine, threonine, cysteine, asparagine, glutamine, asparaginic acid, glutamic acid, lysine, arginine, histidine.

From the group of polymeric carboxylic acids: polyacrylic acid, polymethacrylic acid, alkylacrylamide/acrylic acid-copolymers, alkylacrylamide/methacrylic acid-copolymers, alkylacrylamide/methylmethacrylic acid-copolymers, copolymerse of unsaturated carboxylic acids, vinyl acetate/crotonic acid-copolymers, vinyl pyrrolidone/vinyl acrylate-copolymers.

The spectrum of the inventive preferred zinc salts of organic acids, preferably organic carboxylic acids, ranges from salts that are difficultly soluble or insoluble in water, i.e. with a solubility below 100 mg/l, preferably below 10 mg/l, in particular are insoluble, to such salts with solubilities in water greater than 100 mg/l, preferably over 500 mg/l, particularly preferably over 1 g/l and in particular over 5 g/l (all solubilities at a water temperature of 20° C.). The first group of zinc salts includes zinc citrate, zinc oleate and zinc stearate, the group of soluble zinc salts includes for example, zinc formate, zinc acetate, zinc lactate and zinc gluconate.

In a further preferred embodiment of the present invention, the inventive dispersions comprise at least one zinc salt, however no magnesium salt of an organic acid, wherein at least one zinc salt of an organic carboxylic acid is preferred, particularly preferably a zinc salt from the group zinc stearate, zinc oleate, zinc gluconate, zinc acetate, zinc lactate and/or zinc citrate. Zinc ricinolate, zinc abietate and zinc oxalate are also preferred.

In the context of the present invention, the content of zinc salt in the preferred agent is preferably between 0.1 and 5 wt. %, preferably between 0.2 and 4.0 wt. % and in particular between 0.4 and 3 wt. %. The content of zinc in the oxidized form (calculated as Zn²⁺) between 0.01 and 1 wt. %, preferably between 0.02 and 0.5 wt. % and in particular between 0.04 and 0.2 wt. % respectively, based on the total weight of the dispersion.

If the inventive dispersions are used as dishwasher agents, then these cleaning agents may contain corrosion inhibitors as dispersed materials to protect the tableware or the machine, silver protection agents being particularly important for automatic dishwashers. Substances known from the prior art may be used. Above all, silver protection agents selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferred. Exemplary inventively preferred suitable 3-amino-5-alkyl-1,2,4-triazoles can be cited: 5-propyl-, -butyl-, -pentyl-, -heptyl-, -octyl-, -nonyl-, -decyl-, -undecyl-, -dodecyl-, -isononyl-, -versatic-10-acidalkyl-, -phenyl-, -p-tolyl-, -(4-tert.butylphenyl)-, -(4-methoxyphenyl)-, -(2-,-3-,-4-pyridyl )-, -(2-thienyl)-, -(5-methyl-2-furyl)-, -(5-oxo-2-pyrrolidinyl)-, -3-amino-1,2,4-triazole. In dishwasher agents, the alkylamino-1,2,4-triazoles or their physiologically compatible salts are used in a concentration of 0.001 to 10 wt. %, preferably 0.0025 to 2 wt. %, particularly preferably 0.01 to 0.04 wt. %. Preferred acids for the salt formation are hydrochloric acid, sulfuric acid, phosphoric acid, carbonic acid, sulfurous acid, organic carboxylic acids like acetic acid, glycolic acid, citric acid and succinic acid. Quite particularly active are 5-pentyl-, 5-heptyl-, 5-nonyl-, 5-undecyl-, 5-isononyl-, 5-versatic-10-acidalkyl-3-amino-1,2,4-triazoles as well as mixtures of these substances.

Frequently encountered in cleaning formulations, furthermore, are agents containing active chlorine, which may significantly reduce corrosion of the silver surface. In chlorine-free cleaning products, particular use is made of oxygen-containing and nitrogen-containing organic redox-active compounds, such as difunctional and trifunctional phenols, e.g. hydroquinone, pyrocatechol, hydroxyhydroquinone, gallic acid, phloroglucinol, pyrogallol, and derivatives of these classes of compound. Inorganic compounds in the form of salts and complexes, such as salts of the metals Mn, Ti, Zr, Hf, V, Co and Ce, also find frequent application. Preference is given in this context to the transition metal salts selected from the group consisting of manganese and/or cobalt salts and/or complexes, particularly preferably cobalt amine complexes, cobalt acetato complexes, cobalt carbonyl complexes, the chlorides of cobalt or of manganese and manganese sulfate. Similarly, zinc compounds may be used to prevent corrosion of the tablewares.

Redox-active substances may be added to the inventive dispersions instead of, or in addition to the above described silver protection agents, e.g. the benzotriazoles. These substances are preferably inorganic redox-active substances from the group of salts and/or complexes of manganese, titanium, zirconium, hafnium, vanadium, cobalt or cerium, in which the cited metals exist in the valence states II, III, IV, V or VI.

The metal salts or complexes used should be at least partially soluble in water. Suitable counterions for the salt formation include all usual mono, di or trivalent negatively charged inorganic anions, e.g. oxide, sulfate, nitrate, fluoride and also organic anions e.g. stearate.

In the context of the invention, metal complexes are compounds that consist of a central atom and one or several ligands as well as optionally one or several of the above-mentioned anions in addition. The central atom is one of the above-mentioned metals in one of the above-mentioned valence states. Ligands are neutral molecules or anions, which are monodentate or bidentate; in the context of the invention, the term “Ligands” is discussed in more detail in “Römpp Chemie Lexikon, Georg Thieme Verlag Stuttgart/New York, 9. Edition, 1990, page 2507.” If the charge on the central atom and the charge of the ligand(s) do not add up to zero, then according to whether a cationic or an anionic residual charge is present, either one or several of the above-mentioned anions or one or more of the cations e.g. sodium, potassium, ammonium ions equalise the charge difference. Suitable complex builders are e.g. citrate, acetylacetonate or 1-hydroxyethane-1,1-diphosphonate.

The current definition for “valence state” in chemistry is given in “Römpp Chemie Lexikon, Georg Thieme Verlag Stuttgart/New York, 9. Edition, 1990, page 3168.”

Particularly preferred metal salts and/or metal complexes are selected from the group MnSO₄, Mn(II)-citrate, Mn(II)-stearate, Mn(II)-acetylacetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ as well as their mixtures, such that preferred inventive automatic dishwasher agents are characterized in that the metal salts and/or metal complexes are selected from the group MnSO₄, Mn(II)-citrate, Mn(II)-stearate, Mn(II)-acetylacetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃

These metal salts and/or metal complexes are generally commercially available substances that can be added in the inventive agents for silver corrosion protection without prior cleaning. The mixture of pentavalent and tetravalent vanadium (V₂O₅, V₂O₄, VO₂), known from the SO₃ manufacturing process (Contact Process) is suitable, for example, similarly titanyl sulfate, TiOSO₄ that is formed by diluting a solution of Ti(SO₄)₂.

The inorganic redox-active substances, particularly metal salts or metal complexes are preferably coated, i.e. completely coated with a water-impermeable material that is easily soluble at the cleaning temperature, so as to prevent any premature decomposition or oxidation on storage. Preferred coating materials, which are applied using known processes, for instance hot melt coating process from Sandwik in the food industry, are paraffins, microwaxes, waxes of natural origin such as candelilla wax, carnuba wax, beeswax, higher-melting alcohols such as for example hexadecanol, soaps or fatty acids. The coating material, which is solid at room temperature, is applied in the molten state onto the material to be coated, e.g. by projecting a continuous stream of finely-divided material to be coated through a likewise continuously produced atomized spray zone of molten coating material. The melting point must be chosen such that the coating material easily dissolves during the silver treatment and quickly solidifies. The melting point should ideally lie in the range 45° C. and 65° C. and preferably in the range 50° C. to 60° C.

The cited metal salts and/or metal complexes are comprised in the inventive detergents or cleaning agents, particularly automatic dishwasher agents, preferably in a quantity of 0.05 to 6 wt. %, preferably 0.2 to 2.5 wt. %, based on the total weight of the dispersion.

To increase their washing or cleaning power, agents according to the invention can comprise enzymes as dispersed materials, wherein in principle, any enzyme established for these purposes in the prior art may be used. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The agents according to the invention preferably comprise enzymes in total quantities of 1×10⁶ to 5 weight percent based on active protein. The protein concentration can be determined using known methods, for example the BCA Process or the biuret process.

Preferred proteases are those of the subtilisin type. Examples of these are subtilisins BPN' and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 and TW7. Subtilisin Carlsberg in further developed form is available under the trade name Alcalase® from Novozymes A/S, Bagsvaerd, Denmark. Subtilisins 147 and 309 are commercialised under the trade names Esperase® and Savinase® by the Novozymes company. The variants sold under the name BLAP® are derived from the protease from Bacillus lentus DSM 5483.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents and cleaning agents. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl® ultra, from the Genencor Company under the name Purastar® OxAm and from Daiwa Seiko Inc., Tokyo, Japan as Keistase®. The α-amylase from B. amyloliquefaciens is commercialised by the Novozymes Company under the name BAN®, and derived variants from the α-amylase from B. stearothermophilus under the names BSG® and Novamyl® also from the Novozymes Company.

Moreover, for these purposes, attention should be drawn to the (α-amylase from Bacillus sp. A 7-7 (DSM 12368) and the cyclodextrin-glucanotransferase (CGTase) from B. agaradherens (DSM 9948).

Furthermore, additional developments of α-amylase from Aspergillus niger and A. oryzae available from the Company Novozymes under the trade name Fungamyl® are suitable. A further commercial product is the amylase-LT®, for example.

The agents according to the invention can comprise lipases or cutinases, particularly due to their triglyceride cleaving activities, but also in order to produce in situ peracids from suitable preliminary steps. These include the available or further developed lipases originating from Humicola lanuginosa (Thermomyces lanuginosus), particularly those with the amino acid substitution D96L. They are commercialised, for example by the Novozymes Company under the trade names Lipolase®, Lipolase®Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina and Fusarium solanii are for example available from Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PL® as well as the product Lumafast® from Genencor Company.

The agents according to the invention can comprise additional enzymes, which are summarized under the term hemicellulases. These include, for example mannanases, xanthanlyases, pectinlyases (=pectinases), pectinesterases, pectatlyases, xyloglucanases (=xylanases), pullulanases and β-glucanases. Suitable mannanases, for example are available under the names Gamanase® and Pektinex AR® from Novozymes Company, under the names Rohapec® B1L from AB Enzymes and under the names Pyrolase® from Diversa Corp., San Diego, Calif., USA. β-Glucanase extracted from B. subtilis is available under the name Cereflo® from Novozymes Company.

To augment the bleaching action, the detergents and cleaning agent compositions according to the invention can comprise oxidoreductases, for example oxidases, oxygenases, katalases, peroxidases like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. Advantageously, additional, preferably organic, particularly preferably aromatic compounds are added that interact with the enzymes to enhance the activity of the relative oxidoreductases or to facilitate the electron flow (mediators) between the oxidizing enzymes and the stains over strongly different redox potentials.

The enzymes used in the inventive agents either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added to the inventive agents in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

As an alternative application form, the enzymes can also be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principals, for example stabilizers, emulsifiers, pigments, bleaches or colorants can be applied in additional layers. Such capsules are made using known methods, for example by vibratory granulation or roll compaction or by fluid bed processes. Advantageously, these types of granulates, for example with an applied polymeric film former are dust-free and as a result of the coating are storage stable.

In addition, it is possible to formulate two or more enzymes together, so that a single granulate exhibits a plurality of enzymatic activities.

A protein and/or enzyme in an inventive agent can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. For this use, inventive agents can comprise stabilizers; the supply of these types of agents represents a preferred embodiment of the present invention.

One group of stabilizers are reversible protease inhibitors. For this, benzamidine hydrochloride, borax, boric acids, boronic acids or their salts or esters are frequently used, above all derivatives with aromatic groups, for example ortho, meta or para substituted phenyl boronic acids or the salts or esters. Ovomucoid and leupeptin, inter alia, are mentioned as peptidic protease inhibitors; an additional option is the formation of fusion proteins from proteases and peptide inhibitors.

Further enzyme stabilizers are amino alcohols like mono-, di-, tri-ethanolamine and -propanolamine and their mixtures, aliphatic carboxylic acids up to C₁₂, such as, for example succinic acid, other dicarboxylic acids or salts of the cited acids. End capped alkoxylated fatty acid amides are also suitable. Certain organic acids used as builders can additionally stabilize an included enzyme.

Lower aliphatic alcohols, but above all polyols such as, for example glycerol, ethylene glycol, propylene glycol or sorbitol are further frequently used enzyme stabilizers. Likewise, calcium salts are used, such as for example calcium acetate or calcium formate, and magnesium salts.

Polyamide oligomers or polymeric compounds like lignin, water-soluble vinyl copolymers or cellulose ethers, acrylic polymers and/or polyamides stabilize enzyme preparations against physical influences or pH variations. Polymers that contain polyamine-N-oxide are effective enzyme stabilizers. Other polymeric stabilizers are the linear C₈-C₁₈ polyoxyalkylenes. Alkyl polyglycosides can stabilize the enzymatic components of the inventive agents and even increase their performance. Crosslinked N-containing compounds also act as enzyme stabilizers.

Reducing agents and antioxidants increase the stability of enzymes against oxidative decomposition. A sulfur-containing reducing agent is sodium sulfite, for example.

The use of combinations of stabilizers is preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is increased by the combination with boric acid and/or boric acid derivatives and polyols and still more by the additional effect of divalent cations, such as for example calcium ions.

Preferred dispersions are characterized in that they additionally comprise one or several enzymes and/or enzyme preparations, preferably solid protease preparations and/or amylase preparations in quantities from 0.1 to 5 wt. %, preferably from 0.2 to 4.5 wt. % and in particular from 0.4 to 4 wt. %, each based on the total agent.

Preferred inventive agents are those wherein the dispersed materials, based on their total weight, comprise at least 20 wt. %, preferably at least 30 wt. %, particularly preferably at least 40 wt. % and in particular at least 50 wt. % builder and/or bleaching agent and/or bleach activators and/or active detergent or cleaning polymers and/or glass corrosion protection agents and/or silver protection agents and/or enzymes. Particularly preferred inventive agents consist of at least 90 wt. %, advantageously at least 92 wt. %, preferably at least 94 wt. %, particularly preferably at least 96 wt. %, especially preferably at least 98 wt. % and most preferably at least 99.5 wt. % builder and/or bleaching agent and/or bleach activators and/or active detergent or cleaning polymers and/or glass corrosion protection agents and/or silver protection agents and/or enzymes, in addition to the above-mentioned preferred dispersion agents.

Apart from the earlier described active detergent or cleaning agent substances as preferred dispersion agents or dispersed materials, the inventive detergents or cleaning agents may, of course comprise additional ingredients. These ingredients are advantageously one or several substances from the group of anionic, cationic or amphoteric surfactants, the disintegrators, the acidifiers, the disintegrator auxiliaries, the hydrotropes, the pH adjusters, the colorants, the fragrances, the optical brighteners, the perfumes, the foam inhibitors, the silicone oils, the anti-redeposition agents, the graying inhibitors and the color-transfer inhibitors.

Exemplary suitable anionic surfactants are those of the sulfonate and sulfate type. Suitable surfactants of the sulfonate type are, advantageously C₉₋₁₃-alkylbenzene sulfonates, olefin sulfonates, i.e. mixtures of alkene- and hydroxyalkane sulfonates, and disulfonates, as are obtained, for example, from C₁₂₋₁₈-monoolefins having a terminal or internal double bond by sulfonation with gaseous sulfur trioxide and subsequent alkaline or acidic hydrolysis of the sulfonation products. Alkane sulfonates are also suitable, which are obtained from by sulfochlorination or sulfoxidation, for example, with subsequent hydrolysis and neutralization. The esters of α-sulfofatty acids (ester sulfonates), e.g. the α-sulfonated methyl esters of hydrogenated coco-, palm nut- or tallow acid are likewise suitable.

Further suitable anionic surfactants are sulfated fatty acid esters of glycerine. They include the mono-, di- and triesters and also mixtures of them, such as those obtained by the esterification of a monoglycerol with 1 to 3 moles fatty acid or the transesterification of triglycerides with 0.3 to 2 moles glycerol. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali and in particular sodium salts of the sulfuric acid half-ester derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl residue produced on a petro-chemical basis, which show similar degradation behaviour to the suitable compounds based on fat chemical raw materials. The C₁₂-C₁₆-alkyl sulfates and C₁₂-C₁₅-alkyl sulfates and C₁₄-C₁₅ alkyl sulfates are preferred on the grounds of laundry performance. The 2,3 alkyl sulfates, which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 mols ethylene oxide are also suitable, for example 2-methyl-branched C₉₋₁₁ alcohols with an average of 3.5 mol ethylene oxide (EO) or C₁₂₋₁₈ fatty alcohols with 1 to 4 EO. They are only used in fairly small quantities in cleaning agents due to their high foaming performance, for example up to 5% by weight, generally from 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and in particular ethoxylated fatty alcohols. Preferred sulfosuccinates contain C₈₋₁₈ fatty alcohol residues or mixtures of them. Especially preferred sulfosuccinates contain a fatty alcohol residue derived from the ethoxylated fatty alcohols that are under consideration as non-ionic surfactants (see description below). Once again the particularly preferred sulfosuccinates are those, whose fatty alcohol residues are derived from ethoxylated fatty alcohols with narrow range distribution. It is also possible to use alk(en)ylsuccinic acid with preferably 8 to 18 carbon atoms in the alk(en)y chain or its salts.

Soaps in particular can be considered as further anionic surfactants. Saturated fatty acid soaps are suitable, such as the salts of lauric acid, myristic acid, palmitic acid, stearic acid, hydrogenated erucic acid and behenic acid, and in particular soap mixtures derived from natural fatty acids such as coconut oil fatty acid, palm kernel oil fatty acid or tallow fatty acid.

Anionic surfactants, including soaps may be in the form of their sodium, potassium or ammonium salts or as soluble salts of organic bases, such as mono-, di- or triethanolamine. Preferably, anionic surfactants are in the form of their sodium or potassium salts, in particular in the form of sodium salts.

When the inventive agents are used as automatic dishwasher agents, their content of anionic surfactants is advantageously less than 4% by weight, preferably less than 2% by weight and quite particularly preferably less than 1% by weight. Automatic dishwasher agents, which comprise no anionic surfactants, are particularly preferred.

Cationic and/or amphoteric surfactants can be added instead of, or in combination with the cited surfactants.

As cationic active substances, the products according to the invention may, for example, comprise cationic compounds of the following three Formulae XIX, XX or XXI: 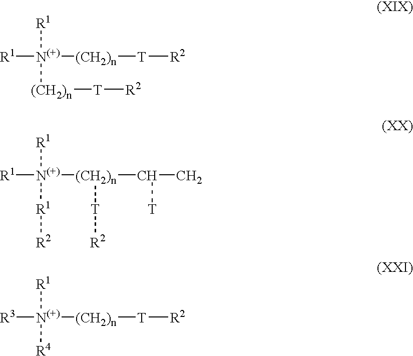
in which each group R¹, independently of one another, is chosen from C₁₋₆-alkyl, -alkenyl or -hydroxyalkyl groups; each group R², independently of one another, is chosen from C₈₋₂₈-alkyl or -alkenyl groups; R³═R¹ or (CH₂)ₙ-T-R²; R⁴═R¹ or R² or (CH₂)ₙ-T-R²; T=—CH₂—, —O—CO— or —CO—O— and n is an integer from 0 to 5.

When the inventive agents are used as automatic dishwasher agents, their content of cationic and/or amphoteric surfactants is advantageously less than 6% by weight, preferably less than 4% by weight, quite particularly preferably less than 2% by weight and in particular less than 1% by weight. Automatic dishwasher agents, which comprise no cationic or amphoteric surfactants, are particularly preferred.

Both inorganic acids and organic acids are available as acidifiers, as long as they are compatible with the usual ingredients. For reasons of consumer protection and handling safety, the solid mono, oligo and polycarboxylic acids are particularly suitable. Within this group, citric acid, tartaric acid, succinic acid, malonic acid, adipic acid, maleic acid, fumaric acid, oxalic acid and polyacrylic acid are again preferred. The anhydrides of these acids can also be used, maleic anhydride and succinic anhydride particularly being commercially available. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifying agent for the purposes of the present invention.

In order to facilitate the disintegration of the inventive agents, disintegration aids, so-called tablet disintegrators, may be incorporated in the agents to shorten their disintegration times. According to Römpp (9th Edition, Vol. 6, page 4440) and Voigt Lehrbuch der pharmazeutischen Technologie. (6th Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

Preferred inventive agents comprise 0.5 to 10 wt. %, advantageously 3 to 7 wt. % and in particular 4 to 6 wt. % of one or several disintegration aids, each based on the weight of the agent.

In the context of the present invention, preferred disintegrators that are used are based on cellulose, and therefore the preferred detergent and cleaning agent compositions comprise such a cellulose-based disintegrator in quantities from 0.5 to 10% by weight, advantageously 3 to 7% by weight and in particular 4 to 6% by weight. Pure cellulose has the formal empirical composition (C₆H₁₀O₅)ₙ and, formally, is a β-1,4-polyacetal of cellobiose which, in turn, is made up of two molecules of glucose. Suitable celluloses consist of ca. 500 to 5000 glucose units and, accordingly, have average molecular weights of 50 000 to 500 000. In the contest of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example granulated or compacted. The particle sizes of such disintegrators are mostly above 200 μm, advantageously with 90 wt. % between 300 and 1600 μm and in particular at least 90 wt. % between 400 and 1200 μm. In the context of the present invention, the above-mentioned coarser disintegration aids, also described in greater detail in the cited publications, are preferred disintegration aids and are commercially available for example, from the Rettenmaier Company under the trade name Arbocel® TF-30-HG.

Microcrystalline cellulose can be used as a further cellulose-based disintegrator, or an ingredient of this component. The microcrystalline cellulose is obtained by the partial hydrolysis of cellulose, under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and for example, compactable granules with an average particle size of 200 μm.

In the context of the present invention, preferred agents additionally comprise a disintegration aid, advantageously a disintegration aid based on cellulose, preferably in granular, cogranulated or compacted form, in quantities of 0.5 to 10 wt. %, advantageously 3 to 7 wt. % and in particular 4 to 6 wt. %, each based on the weight of the agent.

Moreover, the agents according to the invention may comprise a gas-evolving effervescent system. The gas-evolving effervescent system can consist of a single substance, which liberates a gas on contact with water. Among these compounds, particular mention is made of magnesium peroxide, which liberates oxygen on contact with water. Normally, however, the gas-liberating effervescent system consists of at least two ingredients that react with one another to form gas. Although various possible systems could be used, for example systems releasing nitrogen, oxygen or hydrogen, the effervescent system used in the detergent tablets according to the invention should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

Among the alkali metal carbonates or hydrogen carbonates, the sodium and potassium salts are markedly preferred against the other salts for reasons of cost. Naturally, the relevant pure alkali metal carbonates or hydrogen carbonates need not be used; in fact, mixtures of different carbonates and hydrogen carbonates can be preferred.

In preferred inventive agents, 2 to 20% by weight, advantageously 3 to 15% by weight and in particular 5 to 10% by weight of an alkali metal carbonate or -hydrogen carbonate are used as the effervescent system, and 1 to 15, advantageously 2 to 12 and preferably 3 to 10% by weight of an acidifying agent, based on the inventive agent as a whole.

Suitable acidifiers, which liberate carbon dioxide from alkali salts in aqueous solution, are for example, boric acid and alkali metal hydrogen sulfates, alkali metal dihydrogen phosphates and other inorganic salts. Preferably, however, organic acidifiers are used, citric acid being the preferred acidifier. However, solid mono-, oligo- and polycarboxylic acids are also particularly suitable. Within this group, citric acid, tartaric acid, succinic acid, malonic acid, adipic acid, maleic acid, fumaric acid, oxalic acid and polyacrylic acid are again preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifying agent for the purposes of the present invention.

In the context of the present invention, preferred agents are those in which a substance selected from the group of organic di-, tri- and oligocarboxylic acids or mixtures thereof is present as the acidifying agent in the effervescent system.

Colorants and fragrances may be added to the inventive agents in order to improve the aesthetic impression created by the products and to provide the consumer not only with the required performance but also with a visually and sensorially “typical and unmistakable product.” Suitable perfume oils or fragrances include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various perfumes, which together produce an attractive perfume note, are preferably used. Perfume oils such as these may also contain natural perfume mixtures obtainable from vegetal sources, for example pine, citrus, jasmine, patchouli, rose or ylang-ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

The fragrances may be directly incorporated in the detergents according to the invention, although it can also be of advantage to apply the fragrances on carriers that due to a slower fragrance release ensure a long lasting fragrance. Suitable carrier materials are, for example, cyclodextrins, the cyclodextrin/perfume complexes optionally being coated with other auxiliaries.

In order to enhance the esthetic impression of the compositions of the invention, they may be colored with appropriate dyes. Preferred colorants, which are not difficult for the expert to choose, have high storage stability, are not affected by the other ingredients of the agent or by light and do not have any pronounced substantivity for the substrates such as glass, ceramics or plastic dishes being treated with the agent, so as not to color them.

The inventive detergents or cleaning agents, particularly the dispersions, in addition to the previously described active detergent or cleaning agent ingredients, may additionally comprise non-aqueous organic solvents and/or thickeners.

For the inventive agents, this concerns the dispersion of a solid in a dispersion agent (suspension) that inter aliamay also be a non-aqueous solvent. In the context of the present application, the term “solid suspension” does not exclude the fact that the solid substances comprised in the inventive agents are present, at least partially, in solution. Independently of these dissolved contents, the inventive agents have however a content of suspended solid. The above-mentioned non-aqueous solvents come from the groups of mono-alcohols, diols, triols or polyols, the ethers, esters and/or amides for example. Of these, particularly preferred non-aqueous solvents are water-soluble, wherein “water-soluble” solvents in the context of the present application, are solvents that are completely miscible with water at room temperature i.e. without a miscibility gap.

Non-aqueous solvents that can be added to the inventive agents originate from the group of mono- or polyhydroxy alcohols, alkanolamines or glycol ethers, in so far that they are miscible with water in the defined concentration range. Preferably, the solvents are selected from ethanol, n- or i-propanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents.

In the context of the present invention, a particularly preferred inventive dispersion is characterized in that it comprises non-aqueous solvent(s) in quantities of 0.1 to 15 wt. %, preferably from 0.2 to 12 wt. %, particularly preferably from 0.4 to 8 wt. %, quite particularly preferably from 0.8 to 6 wt. % and in particular from 1 to 4 wt. %, each based on the total dispersion, wherein the preferred non-aqueous solvent(s) is/are selected from the group of non-ionic surfactants that are liquid at room temperature, the polyethylene glycols and polypropylene glycols, glycerol, glycerol carbonate, triacetin, ethylene glycol, propylene glycol, propylene carbonate, hexylene glycol, ethanol as well as n-propanol and/or iso-propanol.

In addition to the cited non-aqueous solvents, the inventive detergents or cleaning agents, particularly the dispersions may also comprise additional ingredients for adjusting the viscosity. Their incorporation can be used, for example, to control the settling properties or the casting or flow properties. In particular, combinations of structurants and thickeners have proved themselves in non-aqueous systems.

In the context of the present invention, preferred dispersions further comprise
a) 0.1 to 1.0 wt. % of one or several structurants, advantageously from the group of bentonites and/or at least partially etherified sorbitols and/or
b) 0.1 to 1.0 wt. % of one or several thickeners, advantageously from the group of amorphous or crystalline disilicates, in particular from the group of pyrogenic silicas.

The structurant a) comes from the group of bentonites and/or at least partially etherified sorbitols. These materials are used to assure the physical stability of the agent and to adjust the viscosity.

Bentonites are contaminated clays, which resulted from the weathering of volcanic tuff. Due to their high content of montmorillonite, the bentonites possess valuable properties, such as swelling behavior, ion-exchange properties and thixotropy. The properties of bentonite can be modified according to the end use. Bentonites are frequent components of clay in tropical soils and are extracted as sodium bentonite e.g. in Wyoming, USA. Sodium bentonite possesses the most favorable technical application properties (swellability), and so its use in the context of the present invention is preferred. Naturally occurring calcium bentonites originate for example from Mississippi, USA or Texas, USA or Landshut, Germany. The naturally mined Ca bentonites are synthetically converted to swellable Na bentonites by exchanging Na for Ca.

So-called montmorillonites form the major constituents of bentonites and can also be used in pure form in the context of the present invention. Montmorillonites are phyllosilicates and belong to clays of the dioctahedral smectites, which crystallize as monoclinic-pseudohexagonals. Montmorillonites form predominantly white, grayish to yellowish, completely amorphous looking, easily crushable, water swellable, but non-plastic masses, which can be described by the general Formulae
Al₂[(OH)₂/Si₄O₁₀].nH₂O and/or
Al₂O₃.4SiO₂.H₂O.nH₂O and/or
Al₂[(OH)₂/Si₄O₁₀] (dried at 150°)

Preferred dispersions are characterized in that montmorillonites are added as the structurant. Montmorillonites have a three-layer structure, which consists of two tetrahedral layers that are electrostatically crosslinked through the cations of an octahedral intermediate layer. The layers are not rigidly bonded, but can swell up by reversible inclusion of water (in 2-7 times amounts) and other substances such as e.g. alcohols, glycols, pyridine, a-picoline, ammonium compounds, hydroxyaluminosilicate ions etc. The formulae presented above only represent approximate formulae, as montmorillonites possess a great ion-exchange ability. Thus, Al can be exchanged against Mg, Fe²⁺, Fe³⁺, Zn, Cr, Cu and other ions. As a consequence of such a substitution, there results a negative charge on the layers, which is cancelled out by other cations such as Na⁺ and Ca²⁺.

In combination with bentonites or as a substitute for them, when one does not wish to use them, etherified sorbitols can be used, at least partially, as structurants.

Sorbitol is a hexahydroxy alcohol (sugar alcohol) belonging to the hexitols and can relatively easily eliminate one or two molecules of water and intramolecularly form cyclic ethers (for example sorbitan and sorbid). Water can also be eliminated intermolecularly, forming acyclic ethers from sorbitol and the relevant alcohols. In this case the formation of monoethers and bisethers is possible, also higher degrees of etherification, such as 3 and 4 can occur. In the context of the present invention, preferred partially etherified sorbitols to be added are di-etherified sorbitols, among which dibenzylidene sorbitol being particularly preferred. Here, automatic dishwasher agents are preferred that comprise di-etherified sorbitols, particularly dibenzylidene sorbitol as the structurant.

The inventive agents can comprise the structurants in amounts of 0.1 to 1.0 wt. %, based on the total agent and the active substance of the structurant. Preferred agents comprise the structurants in amounts of 0.2 to 0.9 wt. %, advantageously in quantities of 0.25 to 0.75 wt. % and in particular in quantities of 0.3 to 0.5 wt. %, in each case based on the total weight of the agent.

Pyrogenic silicas are advantageously added as thickeners. Preferred inventive agents comprise the thickeners in amounts of 0.2 to 1.3 wt. %, advantageously in quantities of 0.25 to 1.15 wt. %, preferably in quantities of 0.3 to 1.05 wt. % and in particular in quantities of 0.35 to 0.95 wt. %, in each case based on the total agent.

Further substances that are suitable as thickeners are methyl celluloses, ethyl celluloses, the polyurethanes and the polyacrylates.

The water-content of the inventive dispersions, based on their total weight, is advantageously less than 30 wt. %, preferably less than 23 wt. %, more preferably less than 19 wt. %, particularly preferably less than 15 wt. % and in particular less than than 12 wt. %. Preferred inventive detergents or cleaning agents are low in water or anhydrous. Particularly preferred inventive detergents or cleaning agents are those wherein the dispersion, based on its total weight, has a free water content below 10 wt. %, advantageously below 7 wt. %, particularly preferably below 3 wt. % and in particular below 1 wt. %.

The inventive agents are characterized in that the first active detergent or cleaning preparation has a density between 0.80 and 1.70 g/cm³, advantageously between 0.85 and 1.65 g/cm³, preferably between 1.05 and 1.55 g/cm³ and in particular between 1.10 and 1.50 g/cm³. Inventive detergents or cleaning agents are particularly preferred, in which the first active detergent or cleaning preparation has a density greater than 1.050 g/cm³, advantageously greater than 1.060 g/cm³, or greater than 1.070 g/cm³, or greater than 1.080 g/cm³, or greater than 1.090 g/cm³, or greater than 1.100 g/cm³, or greater than 1.110 g/cm³, or greater than 1.120 g/cm³, or greater than 1.130 g/cm³, or greater than 1.140 g/cm³, or greater than 1.150 g/cm³, or greater than 1.160 g/cm³, or greater than 1.170 g/cm³, or greater than 1.180 g/cm³, or greater than 1.190 g/cm³, or greater than 1.200 g/cm³, or greater than 1.210 g/cm³, or greater than 1.220 g/cm³, or greater than 1.230 g/cm³, or greater than 1.240 g/cm³, or greater than 1.250 g/cm³, or greater than 1.260 g/cm³, or greater than 1.270 g/cm³, or greater than 1.280 g/cm³, or greater than 1.290 g/cm³, or greater than 1.300 g/cm³, or greater than 1.310 g/cm³, or greater than 1.320 g/cm³, or greater than 1.330 g/cm³, or greater than 1.340 g/cm³, or greater than 1.350 g/cm³, or greater than 1.360 g/cm³, or greater than 1.370 g/cm³, or greater than 1.380 g/cm³, or greater than 1.390 g/cm³, or greater than 1.400 g/cm³, or greater than 1.410 g/cm³, or greater than 1.420 g/cm³, or greater than 1.430 g/cm³, or greater than 1.440 g/cm³, or greater than 1.450 g/cm³, or greater than 1.460 g/cm³, or greater than 1.470 g/cm³, or greater than 1.480 g/cm³, or greater than 1.490 g/cm³, or greater than 1.050 g/cm³ Such dispersions are particularly preferred that have a density in the range between 1.040 and 1.700 g/cm³, advantageously between 1.050 and 1.700 g/cm³, advantageously between 1.060 and 1.700 g/cm³, advantageously between 1.070 and 1.700 g/cm³, advantageously between 1.080 and 1.700 g/cm³, advantageously between 1.090 and 1.700 g/cm³, advantageously between 1.100 and 1.700 g/cm³, advantageously between 1.110 and 1.700 g/cm³, advantageously between 1.120 and 1.700 g/cm³, advantageously between 1.130 and 1.700 g/cm³, advantageously between 1.140 and 1.700 g/cm³, advantageously between 1.150 and 1.700 g/cm³, advantageously between 1.160 and 1.700 g/cm³, advantageously between 1.170 and 1.700 g/cm³, advantageously between 1.180 and 1.700 g/cm³, advantageously between 1.190 and 1.700 g/cm³, advantageously between 1.200 and 1.700 g/cm³, advantageously between 1.210.and 1.700 g/cm³, advantageously between 1.220 and 1.700 g/cm³, advantageously between 1.230 and 1.700 g/cm³, advantageously between 1.240 and 1.700 g/cm³, advantageously between 1.250 and 1.700 g/cm³, advantageously between 1.260 and 1.700 g/cm³, advantageously between 1.270 and 1.700 g/cm³, advantageously between 1.280 and 1.700 g/cm³, advantageously between 1.290 and 1.700 g/cm³, advantageously between 1.300 and 1.700 g/cm³, advantageously between 1.310 and 1.700 g/cm³, advantageously between 1.320 and 1.700 g/cm³, advantageously between 1.330 and 1.700 g/cm³, advantageously between 1.340 and 1.700 g/cm³, advantageously between 1.350 and 1.700 g/cm³, advantageously between 1.360 and 1.700 g/cm³, advantageously between 1.370 and 1.700 g/cm³, advantageously between 1.380 and 1.700 g/cm³, advantageously between 1.390 and 1.700 g/cm³, advantageously between 1.400 and 1.700 g/cm³, advantageously between 1.410 and 1.700 g/cm³, advantageously between 1.420 and 1.700 g/cm³, advantageously between 1.430 and 1.700 g/cm³, advantageously between 1.440 and 1.700 g/cm³, advantageously between 1.450 and 1.700 g/cm³, advantageously between 1.460 and 1.700 g/cm³, advantageously between 1.470 and 1.700 g/cm³, advantageously between 1.480 and 1.700 g/cm³, advantageously between 1.490 and 1.700 g/cm³, advantageously between 1.050 and 1.700 g/cm³. Quite particularly preferred dispersions have a density between 1.040 and 1.670 g/cm³, preferably between 1.120 and 1.610 g/cm³, particularly preferably between 1.210 and 1.570 g/cm³, quite particularly preferably between 1.290 and 1.510 g/cm³, and in particular between 1.340 and 1.480 g/cm³.

The density of the added dispersion agents at 20° C. ranges advantageously between 0.8 and 1.4 g/cm³. Water-soluble or water-dispersible polymers with a density (20° C.) above 1.040 g/cm³, advantageously in the range between 1.080 and 1.320 g/cm³ are particularly preferred dispersion agents.

The additional active detergent or cleaning preparation comprised in the inventive combined product is advantageously characterized by a density of more than 0.70 g/cm³. Particularly preferred detergents or cleaning agents are characterized in that the additional active detergent or cleaning preparation has a density between 0.80 and 1.70 g/cm³, advantageously between 0.90 and 1.65 g/cm³, preferably between 0.95 and 1.60 g/cm³ and in particular between 1.00 and 1.50 g/cm³. All the previous density data refer to the densities of the inventive agents at 20° C.

The inventive compositions can be made up and packaged in various ways. Thus, the inventive dispersions can be extruded or cast or compressed into shape, for example. Detergents or cleaning agents can be envisaged, which comprise the inventive dispersion in particulate form with a size in the range between 0.5 and 5 mm, but also larger bodies with at least one side longer than 1 cm, advantageously more than 1.5 cm, particularly more than 2 cm can be manufactured. Thus inventive dispersions are also suitable, for example, as cavity fillings for tablets having cavities or for hollow ring tablets.

In addition to commercially available water-insoluble films, water-soluble or water-dispersible materials are particularly useful for the packaging of the inventive agents. In the context of the present application, inventive detergents or cleaning agents are therefore preferred, which have at least one water-soluble or water-dispersible external material. Accordingly, those inventive agents, whose external material includes a water-soluble or water-dispersible polymer, are particularly preferred. According to the invention, preferred detergents or cleaning agents are consequently those possessing a water-soluble or water-dispersible packaging.

Some particularly preferred water-soluble or water-dispersible packaging materials are listed below:
a) water-soluble non-ionic polymers from the group of
a1) polyvinyl pyrrolidones,
a2) vinyl pyrrolidone/vinyl ester-copolymers,
a3) cellulose ethers
b) water-soluble amphoteric polymers from the group of
b1) alkylacrylamide/acrylic acid-copolymers
b2) alkylacrylamide/methacrylic acid-copolymers
b3) alkylacrylamide/methyl methacrylic acid-copolymers
b4) alkylacrylamide/acrylic acid/alkylaminoalkyl(meth)acrylic acid-copolymers
b5) alkylacrylamide/methacrylic acid/alkylaminoalkyl(meth)acrylic acid-copolymers
b6) alkylacrylamide/methyl methacrylic acid/alkylaminoalkyl(meth)acrylic acid-copolymers
b7) alkylacrylamide/alkyl methacrylic acid/alkylaminoethyl methacrylate/alkyl methacrylate-copolymers
b8) copolymers of
   b8i) unsaturated carboxylic acids,
   b8ii) cationic derivatized unsaturated carboxylic acids
   b8iii) optional additional ionic or non-ionic monomers.
c) water-soluble zwitterionic polymers from the group of
c1) acrylamidoalkyltrialkylammonium chloride/acrylic acid-copolymers as well as their alkali- and ammonium salts
c2) acrylamidoalkyltrialkylammonium chloride/methacrylic acid-copolymers as well as their alkali- and ammonium salts
c3) methacroyl ethylbetain/methacrylate-copolymers
d) water-soluble anionic polymers from the group of
d1) vinyl acetate/crotonic acid-copolymers
d2) vinyl pyrrolidone/vinyl acrylate-copolymers
d3) acrylic acid/ethyl acrylate/N-tert.butylacrylamide-terpolymers
d4) Grafted polymers of vinyl esters, esters of acrylic acid or methacrylic acid alone or in mixtures, copolymers with crotonic acid, acrylic acid or methacrylic acid with polyalkylene oxides and/or polyalkylene glycols
d5) grafted and crosslinked copolymers from the copolymerization of
   d5i) at least one monomer of the non-ionic type,
   d5ii) at least one monomer of the ionic type,
   d5iii) polyethylene glycol, and
   d5iv) a crosslinker
d6) copolymers obtained by copolymerizing at least one monomer from each of the three following groups:
d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group ii) with saturated or unsaturated, straight-chain or branched C₈₋₁₈ alcohols
d7) terpolymers of crotonic acid, vinyl acetate and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters or straight chain allyl or methallyl esters
d9) crotonic acid copolymers with one or more monomers from the group consisting of ethylene, vinylbenzene, vinyl methyl ether, acrylamide and the water-soluble salts thereof
d10) terpolymers of vinyl acetate, crotonic acid and vinyl esters of a saturated aliphatic a-branched monocarboxylic acid.
e) water-soluble cationic polymers from the group of
e1) quaternized cellulose derivatives
e2) polysiloxanes with quaternary groups
e3) cationic guar derivatives
e4) polymeric dimethyldiallylammonium salts and their copolymers with esters and amides of acrylic acid and methacrylic acid
e5) copolymers of vinyl pyrrolidone with quaternized derivatives of dialkylaminoacrylate and dialkylaminomethacrylate
e6) vinyl pyrrolidone-methoimidazolinium chloride-copolymers
e7) quaternized polyvinyl alcohol
e8) polymers described by the INCI designations Polyquaternium 2, Polyquaternium 17, Polyquaternium 18 and Polyquaternium 27

Water-soluble polymers in the context of the invention are such polymers that have a solubility higher than 2.5 wt. % in water at room temperature.

Preferred external coating materials preferably include at least in part, one substance from the group (acetalized) polyvinyl alcohol, polyvinyl pyrrolidone, polyethylene oxide and gelatin.

“Polyvinyl alcohols” (abbreviation PVAL, sometimes also PVOH) is the term for polymers with the general structure 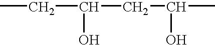
which comprise lesser amounts (ca. 2%) of structural units of the type

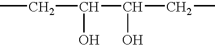

Typical commercial polyvinyl alcohols, which are offered as yellowish white powders or granules having degrees of polymerization in the range of approx. 100 to 2500 (molar masses of approximately 4000 to 100 000 g/mol), have degrees of hydrolysis of 98-99 or 87-89 molar % and thus still have a residual acetyl group content. The manufacturers characterize the polyvinyl alcohols by stating the degree of polymerization of the initial polymer, the degree of hydrolysis, the saponification number and/or the solution viscosity.

The solubility in water and in a few strongly polar organic solvents (formamide, dimethylformamide, dimethyl sulfoxide) of polyvinyl alcohols is a function of the degree of hydrolysis; they are not attacked by (chlorinated) hydrocarbons, esters, fats or oils. Polyvinyl alcohols are classed as toxicologically unobjectionable and are at least partially biodegradable. The solubility in water can be reduced by post-treatment with aldehydes (acetalization), by complexing with Ni salts or Cu salts or by treatment with dichromates, boric acid or borax. The coatings of polyvinyl alcohol are substantially impenetrable to gases such as oxygen, nitrogen, helium, hydrogen, carbon dioxide, but do allow water vapor to pass.

In the context of the present invention, it is preferred that an inventive agent exhibits at least one packaging material or external material that at least partially includes a polyvinyl alcohol whose degree of hydrolysis is 70 to 100 molar %, preferably 80 to 90 molar %, with particular preference from 81 to 89 molar %, and in particular from 82 to 88 molar %. In a preferred embodiment, the at least one added external material consists of at least 20 wt. %, particularly preferably of at least 40 wt. %, quite particularly preferably of at least 60 wt. % and in particular of at least 80 wt. % of a polyvinyl alcohol, whose degree of hydrolysis ranges from 70 to 100 molar %, advantageously 60 to 90 molar %, particularly preferably 81 to 89 molar % and in particular 82 to 88 molar %. Advantageously, the total added external material consists of at least 20 wt. %, particularly preferably of at least 40 wt. %, quite particularly preferably of at least 60 wt. % and in particular of at least 80 wt. % of a polyvinyl alcohol, whose degree of hydrolysis ranges from 70 to 100 molar %, advantageously 80 to 90 molar %, particularly preferably 81 to 89 molar % and in particular 82 to 88 molar %.

Preferably, polyvinyl alcohols of a defined molecular weight range are used for the external coating materials, wherein according to the invention it is preferred that the external coating material includes a polyvinyl alcohol whose molecular weight lies in the range 10 000 to 100 000 gmol⁻¹, advantageously from 11 000 gmol-1 to 90 000 gmol⁻¹, with particular preference from 12 000 to 80 000 gmol⁻¹, and in particular from 13 000 to 70 000 gmol⁻¹.

The degree of polymerization of such preferred polyvinyl alcohols lies between approximately 200 to approximately 2100, advantageously between approximately 220 to approximately 1890, particularly preferably between approximately 240 to approximately 1680, and in particular between approximately 260 to approximately 1500. Inventive detergents or cleaning agents with water-soluble or water-dispersible packaging are characterized in that the water-soluble or water-dispersible packaging material includes polyvinyl alcohol and/or PVAL-copolymers, whose average degree of polymerization lies between 80 and 700, advantageously between 150 and 400, particularly preferably between 180 and 300, and/or whose molecular weight ratio MW(50%) to MW(90%) lies between 0.3 and 1, advantageously between 0.4 and 0.8 and in particular between 0.45 and 0.6.

The above-described polyvinyl alcohols are widely commercially available, for example under the trade name Mowiol® (Clariant). Examples of polyvinyl alcohols which are particularly suitable in the context of the present invention are Mowiol® 3-83, Mowiol® 4-88, Mowiol® 5-88, Mowiol® 8-88 as well as Mowiflex LPTC 221 ex KSE together with compounds from Texas Polymers such as for example Vinex 2034.

Further polyvinyl alcohols that are particularly suitable as packaging materials are to be found in the following table:

| | Hydrolysis | Mol | Melting point |
|---|---|---|---|
| Name | Degree [%] | Wt [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23 600 | 100 |
| Gohsefimer ® LL02 | 41-51 | 17 700 | 100 |

Further polyvinyl alcohols that are suitable as materials for the water-soluble or water-dispersible films and/or container are ELVANOL® 51-05, 52-22, 50-42, 85-82, 75-15, T-25, T-66, 90-50, (trade mark of Du Pont), ALCOTEX® 72.5, 78, B72, F80/40, F88/4, F88/26, F88/40, F88/47, (trade mark of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trade mark of Nippon Gohsei K. K.). ERKOL types from Wacker are also suitable.

The water content of preferred PVAL packaging materials is advantageously less than 10% by weight, preferably less than 8% by weight, quite particularly preferably less than 6% by weight and in particular less than 4% by weight.

The water solubility of PVAL can be modified by post-treatment with aldehydes (acetalization) or ketones (ketalization). Polyvinyl alcohols, which are acetalized or ketalized with the aldehyde or ketone groups of saccharides or polysaccharides or their mixtures, have proved to be particularly preferred and because of their extremely good solubility in cold water, particularly advantageous. The reaction products of PVAL and starch are used most advantageously.

Moreover, the water-solubility can be adjusted and controlled to required values by complexation with Ni salts or Cu salts or by treatment with dichromates, boric acid or borax. The films of polyvinyl alcohol are substantially impenetrable to gases such as oxygen, nitrogen, helium, hydrogen, carbon dioxide, but do allow water vapor to pass.

Exemplary suitable water-soluble PVAL films are available under the trade name “SOLUBLON®” from Syntana Handelsgesellschaft E.Harke Gmbh & Co. Their solubility in water can be adjusted exactly and films of this product series are available, which are soluble in aqueous phase over all temperature ranges relevant to each application.

Preferred inventive detergents or cleaning agents with a water-soluble or water-dispersible packaging are characterized in that the water-soluble or water-dispersible packaging comprises hydroxypropyl methylcellulose (HPMC), which has a degree of substitution (average number of methoxy groups per anhydroglucose unit of the cellulose) from 1.0 to 2.0. advantageously from 1.4 to 1.9, and a molar substitution (average number of hydroxypropyl groups per anhydroglucose unit of the cellulose) from 0.1 to 0.3, advantageously from 0.15 to 0.25.

Polyvinyl pyrrolidones, abbreviated “PVP,” can be described by means of the general Formula:

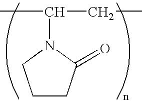

PVP are manufactured by radical polymerization of 1-vinyl pyrrolidone. Commercial PVP have molecular weights in the range 2500 to 750 000 g/mol and are supplied as white, hygroscopic powders or as aqueous solutions.

Polyethylene oxides, abbreviated to PEOX, are polyalkylene glycols of the general Formula
H—[O—CH₂—CH₂]ₙ—OH
which are manufactured industrially by the base catalyzed polyaddition of ethylene oxide (oxirane) in systems with the least possible water content with ethylene glycol as the starting molecule. They have molecular weights from ca. 200 to 5 000 000 g/mol, corresponding to degrees of polymerization n of ca. 5 to >100 000. Polyethylene oxides possess an extremely low concentration of reactive hydroxy end groups and show only weak glycol properties.

Gelatin is a polypeptide (molecular weight: approx. 15 000 to >250 000 g/mol) obtained principally by hydrolysis under acidic or alkaline conditions of the collagen present in the skin and bones of animals. The amino acid composition of gelatin corresponds largely to that of the collagen from which it was obtained, and varies as a function of its provenance. The use of gelatin as a water-soluble coating material is extremely widespread, in particular in pharmacy, in the form of hard or soft gelatin capsules. Gelatin in the form of films finds only limited use, due to its high price compared with the above-cited polymers.

In the context of the present invention, external materials are preferred, which include a polymer from the group starch and starch derivatives, cellulose and cellulose derivatives, particularly methyl cellulose and mixtures thereof.

Starch is a homoglycan in which the glucose units are attached by α-glycoside bonds. Starch is made up of two components of different molecular weight, namely ca. 20-30% straight-chain amylose (molecular weight ca. 50 000 to 150 000) and 70-80% of branched-chain amylopectin (molecular weight ca. 300 000 to 2 000 000). Small quantities of lipids, phosphoric acid and cations are also present. Whereas the amylose—on account of the bond in the 1,4-position—forms long, helical entwisted chains containing about 300 to 1 200 glucose molecules, the amylopectin chain branches through a 1,6-bond after—on average—25 glucose units to form a branch-like structure containing about 1 500 to 12 000 glucose molecules. Besides pure starch, starch derivatives obtainable from starch by polymer-analog reactions may also be used in the context of the present invention for the production of water-soluble coatings for the detergent, rinse agent and cleaning agent portions. These chemically modified starches include, for example, products of esterification or etherification reactions in which hydroxy hydrogen atoms have been substituted. However, starches in which the hydroxy groups have been replaced by functional groups that are not attached by an oxygen atom may also be used as starch derivatives. The group of starch derivatives includes, for example, alkali metal starches, carboxymethyl starches (CMS), starch esters and ethers and amino starches.

Pure cellulose has the formal empirical composition (C₆H₁₀O₅)ₙ and, formally, is a β-1,4-polyacetal of cellobiose, which, in turn, is made up of two molecules of glucose. Suitable celluloses consist of ca. 500 to 5 000 glucose units and, accordingly, have average molecular weights of 50 000 to 500 000. In the contest of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses.

Preferred water-soluble or water-dispersible packaging includes a receptacle with at least one receiving chamber. In the context of the present invention, however, particularly preferred receptacles have two, three, four or five receiving chambers. Each of these receiving chambers can have a closure. According to the invention, such detergent or cleaning agents are preferred, whose water-soluble or water-dispersible packaging has at least one closure. Here, for example, two or more receiving chambers can also be sealed with a single closure, however several receiving chambers can also be provided with their own closure.

The dissolution behavior of the water-soluble or water-dispersible packaging (container and closure) can be influenced not only by the chemical composition of the external coating material, but also, for example, by the thickness of the container walls or the closure. In the context of the present application, preferred agents are characterized in that the container and/or the closure(s) has/have a thickness of 5 to 2000 μm, advantageously 6 to 1000 μm, particularly preferably 7 to 500 μm, quite particularly preferably 8 to 200 μm and in particular 10 to 100 μm. Thus, it is particularly preferred to use containers and closures of different thicknesses, such agents being advantageous that have their closures of thinner walls than their corresponding containers.

As the wall thickness of the water-soluble or water-dispersible packaging has an influence on the dissolution behavior of the inventive agents, in the context of the present application, particularly fast dissolving detergents or cleaning agents are preferred, however, the water-soluble or water-dispersible packaging of the particularly preferred detergents and cleaning agents includes at least one water-soluble or water-dispersible container and/or at least one water-soluble or water-dispersible closure, wherein the container and/or the closure has a wall thickness below 200 μm, preferably below 120 μm, particularly preferably below 90 μm and in particular below 70 μm. In a particularly preferred embodiment, both the water-soluble or water-dispersible container and the water-soluble or water-dispersible closure has a wall thickness below 200 μm, preferably below 120 μm, particularly preferably below 90 μm and in particular below 70 μm.

Preferred inventive agents are characterized in that the water-soluble or water-dispersible packaging is at least partially transparent or translucent.

The packaging used is preferably transparent. In the context of this invention, transparency is understood to mean that the transmittance in the visible spectrum of light (410 to 800 nm) is greater than 20%, advantageously greater than 30%, most preferably greater than 40% and in particular greater than 50%. Thus, as soon as a wavelength of the visible spectrum of light has a transmission greater than 20%, then in the context of the invention it is to be considered as transparent.

When the packaging, the external coating material consists, for example, of a receiving container and a closure, then preferably, at least the receiving container or the closure is transparent or translucent. However, particularly preferred packaging of a receiving container and a closure are those in which both the receiving container and the closure are transparent or translucent.

According to the invention, preferred agents that at least partially possess a transparent external coating material can comprise stabilizers. In the context of the invention, stabilizers are materials that protect the ingredients in the receiving chamber and/or in the intermediate space from decomposition or deactivation from light irradiation. Antioxidants, UV-absorbers and fluorescent dyes have proven to be particularly suitable.

In the context of the invention, antioxidants are particularly suitable stabilizers. The formulations can comprise antioxidants in order to prevent undesirable changes to the formulation caused by light irradiation and radically induced decomposition. Phenols, bisphenols and thiobisphenols, substituted with sterically hindered groups can be used, for example, as antioxidants. Further examples are propyl gallate, butylhydroxytoluene (BHT), butylhydroxyanisole (BHA), t-butylhydroquinone (TBHQ), tocopherol and the long-chained (C8-C22) esters of gallic acid, such as dodecyl gallate. Other substance classes are aromatic amines, preferably secondary aromatic amines and substituted p-phenylenediamines, phosphorus compounds with trivalent phosphorus such as phosphines, phosphites and phosphonites, citric acids and citric acid derivatives, such as isopropyl citrate, compounds with ene-diol groups, so-called reductonesa, such as ascorbic acid and its derivatives, such as ascorbic acid palmitate, organosulfur compounds, such as the esters of 3,3′-thiodipropionic acid with C₁₋₁₈-alkanols, particularly C₁₀₋₁₈-alkanols, metal deactivators, which are capable of complexing autoxidative catalytic metal ions such as copper, like nitriloacetic acid and its derivatives and their mixtures. The antioxidants can be comprised in the formulations in amounts up to 35 wt. %, preferably up to 25 wt. %, particularly preferably from 0.01 to 20 and in particular from 0.03 to 20 wt. %.

A further class of preferred suitable stabilizers are the UV-absorbers. UV-absorbers can improve the light stability of the ingredients of the composition. UV-absorbers are understood to mean organic substances (light protective filters), which are able to absorb UV radiation and emit the resulting energy in the form of longer wavelength radiation, for example as heat. Compounds, which possess these desired properties, are for example, the efficient radiationless deactivating compounds and derivatives of benzophenone having substituents in position(s) 2 and/or 4. Also suitable are substituted benzotriazoles, such as for example the water-soluble sodium salt of 3-(2H-benzotriazole-2-yl)-4-hydroxy-5-(methylpropyl)-benzenesulfonic acid (Cibafast® H), acrylates, which are phenyl-substituted in position 3 (cinnamic acid derivatives) optionally with cyano groups in position 2, salicylates, organic Ni complexes, as well as natural substances such as umbelliferone and the endogenous urocanic acid. The biphenyl and above all the stilbene derivatives which are commercially available as Tinosorb® FD or Tinosorb® FR from Ciba, are of particular importance. As UV-B absorbers can be cited: 3-benzylidenecamphor or 3-benzylidenenorcamphor and its derivatives, for example 3-(4-methylbenzylidene) camphor, 4-aminobenzoic acid derivatives, preferably 2-ethylhexyl ester of 4-(dimethylamino)benzoic acid, 4-(dimethylamino)benzoic acid, 2-octyl ester and 4-(dimethylamino)benzoic acid, amyl ester; esters of cinnamic acid, preferably 4-methoxycinnamic acid, 2-ethylhexyl ester, 4-methoxycinnamic acid, propyl ester, 4-methoxycinnamic acid, isoamyl ester, 2-cyano-3,3-phenylcinnamic acid, 2-ethylhexyl ester (octocrylene); esters of salicylic acid, preferably salicylic acid, 2-ethylhexyl ester, salicylic acid, 4-isopropylbenzyl ester, salicylic acid, homomenthyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzmalonic acid, di-2-ethylhexylester; triazine derivatives, such as, for example 2,4,6-trianilino-(p-carbo-2′-ethyl-1′-hexyloxy)-1,3,5-triazine and octyl triazone, or dioctyl butamidotriazone (Uvasorb® HEB); propane-1,3-dione, such as for example 1-(4-tert.butylphenyl)-3-(4′-methoxyphenyl)propane-1,3-dione; ketotricyclo(5.2.1.0) decane derivatives. Further suitable are 2-phenylbenzimidazole-5-sulfonic acid and its alkali-, earth alkali-, ammonium-, alkylammonium-, alkanolammonium- and glucammonium salts; sulfonic acid derivatives of benzophenones, preferably 2-hydroxy-4-methoxybenzophenone-5-sulfonic acid and its salts; sulfonic acid derivatives of 3-benzylidenecamphor, such as for example 4-(2-oxo-3-bornylidenemethyl)benzene sulfonic acid and 2-methyl-5-(2-oxo-3-bornylidene) sulfonic acid and its salts.

Typical UV-A filters particularly include derivatives of benzoylmethane, such as, for example 1-(4′-tert.-butylphenyl)-3-(4′-methoxyphenyl)propane-1,3-dione, 4-tert.-butyl-4′-methoxydibenzoylmethane (Parsol 1789),1-phenyl-3-(4′-isopropylphenyl)-propane-1,3-dione as well as enamine compounds. Naturally, the UV-A and UV-B filters can also be added as mixtures. Beside the cited soluble materials, insoluble, light-protecting pigments, namely finely dispersed, preferably, nano metal oxides or salts can also be considered for this task. Exemplary suitable metal oxides are particularly zinc oxide and titanium oxide and also oxides of iron, zirconium, silicon, manganese, aluminum and cerium as well as their mixtures. Silicates (talc), barium sulfate or zinc stearate can be added as salts. The oxides and salts are already used in the form of pigments for skin care and skin protecting emulsions and decorative cosmetics. Here, the particles should have a mean diameter of less than 100 nm, preferably between 5 and 50 nm and in particular between 15 and 30 nm. They can be spherical, however elliptical or other shaped particles can also be used. The pigments can also be surface treated, i.e. hydrophilized or hydrophobized. Typical examples are coated titanium dioxides, such as, for example Titandioxid T 805 (Degussa) or Eusolex® T2000 (Merck). Hydrophobic coating agents preferably include trialkoxy octylsilanes or Simethicones. Micronized zinc oxide is preferably used.

UV absorbers can be comprised in quantities up to 5 wt. %, advantageously up to 3 wt. %, particularly preferably 0.01 wt. % to 2.0 and in particular from 0.03 wt. % to 1 wt. %, each based on the total weight of a mixture of substances present in a receiving chamber or an intermediate space.

A further preferred class of stabilizers are the fluorescent dyes. They include 4,4′-diamino-2,2′-stilbenedisulfonic acids (flavonic acids), 4,4′-distyrylbiphenylene, methylumbelliferone, cumarine, dihydroquinolinones, 1,3-diarylpyrazolines, naphthoic acid imide, benzoxazole-, benzisoxazole- and benzimidazole-systems as well as heterocyclic substituted pyrene derivatives. The sulfonic acid salts of diaminostilbene derivatives and polymeric fluorescent dyes are of particular importance.

The fluorescence dyes can be comprised in quantities up to 5 wt. %, advantageously up to 1 wt. %, particularly preferably 0.01 wt. % to 0.5 and in particular from 0.03 wt. % to 0.1 wt. %, each based on the total weight of a mixture of substances present in a receiving chamber or an intermediate space.

In a preferred embodiment, the above-mentioned stabilizers are used in any mixtures. The stabilizers are used in quantities up to 40 wt. %, advantageously up to 30 wt. %, particularly preferably 0.01 wt. % to 20 wt. % and in particular from 0.02 wt. % to 5 wt. %, each based on the total weight of a mixture of substances present in a receiving chamber or an intermediate space.

In a further preferred embodiment of the present application, inventive agents are preferred, which provide in the container, preferably, however, in its closure, a device for pressure equilibration between the inside of the container and the surrounding atmosphere. Such a pressure equilibration device is particularly preferred for those inventive agents, in which the inside of the container is filled up with those liquids or solid active substances that tend to liberate gases after the container is sealed with a closure. The cause of such gas liberations are generally chemical reactions, particularly
reactions between the agents in the container and the external coating materials or
reactions between the agents in the container and substances that have diffused through the external coating material into the container interior (e.g. water) or
reactions of the agents in the container with each other or
decomposition reactions caused by light or heat on individual agents present in the container.
   Those active substances, which tend to liberate gas according to one of the described reactions, particularly include the bleaching agents described below, for example the percarbonates and the perborates. In the context of the present application, devices for pressure equilibration particularly include valves, preferably however microholes, preferably microholes with a diameter between 0.1 and 2 mm, particularly preferably between 0.2 and 1.5 mm and in particular between 0.5 and 1 mm. The layout of the microholes can, for example, be automated by the use of perforators, which “drill through” the packaging or external coating material, wherein this “drilling through” can be accomplished either before filling or sealing the packaging or after the sealing operation. When the receiving container or the closure is “drilled through” prior to the filling or sealing operation, then the penetration of the external coating material is preferably made from the inside of the coating material, i.e. from the side, which is present on the inside of the container after sealing, towards the exterior of the external coating material. Beside microholes, microchannels or the use of permeable external coating materials are also suitable for making a pressure equilibration.

According to the invention, the dispersions are combined with an additional active detergent or cleaning preparation. Thus, both the dispersions and the additional active detergent or cleaning preparation can comprise a complete detergent or cleaning agent recipe, however both of the preparations, in regard to their ingredients, can also differ from each other or complement each other. In a preferred embodiment of the present application, the additional active detergent or cleaning preparation is a solid or a mixture of solids, advantageously a powder or a granulate or an extrudate or a compaction or one or more cast bodies.

In the context of this application, solids include, for example, powders, granulates, extrudates, compactions like tablets, cast bodies or shape-stable gels. The solid or liquid detergent or cleaning agents that are added in combination with the dispersions, may naturally have all the usual ingredients in the field of detergents and cleaning agents, however, their compositions preferably differ from the composition of the dispersion. Particularly preferred inventive agents are those in which the dispersion is combined with a powder. Suitable ingredients for the solid or liquid detergents or cleaning agents are particularly the builders, surfactants, bleaching agents, bleach activators, polymers, enzymes, glass corrosion protection agents, silver protection agents, colorants, fragrances, pH-adjustors and disintegrators. To avoid repetition, an exact description of these ingredients is referred to in the previous paragraphs.

The inventive detergent or cleaning agent is a combined product of a dispersion and additional solid or liquid detergents or cleaning agents. It is preferred according to the invention, that the dispersion(s), based on the total composition of the combined product, comprise(s)
at least 20 wt. %, preferably at least 50 wt. %, particularly preferably at least 70 wt. % and in particular at least 90 wt. % of the anionic and/or cationic and/or amphoteric polymers comprised in the combined product; and/or
at least 20 wt. %, preferably at least 40 wt. %, particularly preferably at least 60 wt. % and in particular at least 80 wt. % of the non-ionic surfactants comprised in the combined product; and/or
at least 10 wt. %, preferably between 20 and 90 wt. %, particularly preferably between 30 and 85 wt. % and in particular between 40 and 80 wt,% of the builders, preferably of phosphates or citrates, in the combined product.

As disclosed previously, the inventive agents are, however, preferably made up in water-soluble or water-dispersible packaging, wherein this packaging can, for example, consist of a container having one, two, three or more receiving chambers. Beside the inventive dispersions, also other liquids and solids, such as powders, granulates, extrudates, compactions, cast bodies or shape-stable gels are suitable ingredients for the receiving chambers. In addition to low-viscosity liquids or flowable gels or flowable dispersions, suitable liquids are, for example emulsions or suspensions. Active principals or combinations of active principals are considered to be flowable when they do not have their own dimensional stability that allows them, under normal conditions of manufacture, storage, transport and consumer utilization, to assume a non-disintegrated shape, wherein this shape does not change under the cited conditions, even over a longer period, preferably 4 weeks, particularly preferably 8 weeks and in particular 32 weeks, i.e. that under normal conditions of manufacture, storage, transport and utilization by the customer remains in the spatial and geometric shape defined by their manufacture, i.e. does not deliquesce. The determination of flowabilty particularly relates to the usual conditions of storage and transport, i.e. particularly for temperatures below 50° C., preferably 40° C. Active principals or combinations of active principals having a melting point below 25° C., preferably below 20° C., particularly preferably below 15° C. are considered here as liquids.

In the context of the present application, detergents and cleaning agents are preferred, in which the additional active detergent or cleaning preparation is a liquid, preferably a gel.

To combine the above-mentioned ready-made forms of solid and liquid detergent or cleaning agent with the dispersions, there are a number of possibilities. Several preferred embodiments are described in the following Table. The receiving chambers filled with liquid, powder or granulate are preferably sealed. For the receiving chambers filled with compactions, extrudates, cast bodies or shape-stable gels, sealing is optional, but preferred.

Water-soluble or water-dispersible packaging with one receiving chamber:

Receiving Chamber 1

dispersion and liquid
dispersion and powder
dispersion and granulate
dispersion and compaction
dispersion and extrudate
dispersion and cast body
dispersion and shape-stable gel

Water-soluble or water-dispersible packaging with two receiving chambers:

| Receiving Chamber 1 | Receiving Chamber 2 |
|---|---|
| Dispersion | Liquid |
| Dispersion | Powder |
| Dispersion | Granulate |
| Dispersion | Compaction |
| Dispersion | Extrudate |
| Dispersion | Cast body |
| Dispersion | Shape-stable gel |
| Dispersion | Dispersion 2 |
| Dispersion and powder | Liquid |
| Dispersion and powder | Powder |
| Dispersion and powder | Granulate |
| Dispersion and powder | Compaction |
| Dispersion and powder | Extrudate |
| Dispersion and powder | Cast body |
| Dispersion and powder | Shape-stable gel |
| Dispersion and powder | Dispersion 2 |
| Dispersion and granulate | Liquid |
| Dispersion and granulate | Powder |
| Dispersion and granulate | Granulate |
| Dispersion and granulate | Compaction |
| Dispersion and granulate | Extrudate |
| Dispersion and granulate | Cast body |
| Dispersion and granulate | Shape-stable gel |
| Dispersion and granulate | Dispersion 2 |
| Dispersion and compaction | Liquid |
| Dispersion and compaction | Powder |
| Dispersion and compaction | Granulate |
| Dispersion and compaction | Compaction |
| Dispersion and compaction | Extrudate |
| Dispersion and compaction | Cast body |
| Dispersion and compaction | Shape-stable gel |
| Dispersion and compaction | Dispersion 2 |
| Dispersion and extrudate | Liquid |
| Dispersion and extrudate | Powder |
| Dispersion and extrudate | Granulate |
| Dispersion and extrudate | Compaction |
| Dispersion and extrudate | Extrudate |
| Dispersion and extrudate | Cast body |
| Dispersion and extrudate | Shape-stable gel |
| Dispersion and extrudate | Dispersion 2 |
| Dispersion and cast body | Liquid |
| Dispersion and cast body | Powder |
| Dispersion and cast body | Granulate |
| Dispersion and cast body | Compaction |
| Dispersion and cast body | Extrudate |
| Dispersion and cast body | Cast body |
| Dispersion and cast body | Shape-stable gel |
| Dispersion and cast body | Dispersion 2 |

Water-soluble or water-dispersible packaging with three receiving chambers:

| Receiving Chamber 1 | Receiving Chamber 2 | Receiving Chamber 3 |
|---|---|---|
| Dispersion | Liquid | Liquid |
| Dispersion | Powder | Liquid |
| Dispersion | Granulate | Liquid |
| Dispersion | Compaction | Liquid |
| Dispersion | Extrudate | Liquid |
| Dispersion | Cast body | Liquid |
| Dispersion | Shape-stable gel | Liquid |
| Dispersion | Liquid | Powder |
| Dispersion | Powder | Powder |
| Dispersion | Granulate | Powder |
| Dispersion | Compaction | Powder |
| Dispersion | Extrudate | Powder |
| Dispersion | Cast body | Powder |
| Dispersion | Shape-stable gel | Powder |
| Dispersion | Liquid | Granulate |
| Dispersion | Powder | Granulate |
| Dispersion | Granulate | Granulate |
| Dispersion | Compaction | Granulate |
| Dispersion | Extrudate | Granulate |
| Dispersion | Cast body | Granulate |
| Dispersion | Shape-stable gel | Granulate |
| Dispersion | Liquid | Compaction |
| Dispersion | Powder | Compaction |
| Dispersion | Granulate | Compaction |
| Dispersion | Compaction | Compaction |
| Dispersion | Extrudate | Compaction |
| Dispersion | Cast body | Compaction |
| Dispersion | Shape-stable gel | Compaction |
| Dispersion | Liquid | Extrudate |
| Dispersion | Powder | Extrudate |
| Dispersion | Granulate | Extrudate |
| Dispersion | Compaction | Extrudate |
| Dispersion | Extrudate | Extrudate |
| Dispersion | Cast body | Extrudate |
| Dispersion | Shape-stable gel | Extrudate |
| Dispersion | Liquid | Cast body |
| Dispersion | Powder | Cast body |
| Dispersion | Granulate | Cast body |
| Dispersion | Compaction | Cast body |
| Dispersion | Extrudate | Cast body |
| Dispersion | Cast body | Cast body |
| Dispersion | Shape-stable gel | Cast body |
| Dispersion | Liquid | Shape-stable gel |
| Dispersion | Powder | Shape-stable gel |
| Dispersion | Granulate | Shape-stable gel |
| Dispersion | Compaction | Shape-stable gel |
| Dispersion | Extrudate | Shape-stable gel |
| Dispersion | Cast body | Shape-stable gel |
| Dispersion | Shape-stable gel | Shape-stable gel |
| Dispersion | Liquid | Dispersion 2 |
| Dispersion | Powder | Dispersion 2 |
| Dispersion | Granulate | Dispersion 2 |
| Dispersion | Compaction | Dispersion 2 |
| Dispersion | Extrudate | Dispersion 2 |
| Dispersion | Cast body | Dispersion 2 |
| Dispersion | Shape-stable gel | Dispersion 2 |

When water-soluble or water-dispersible packaging is used for packaging the inventive combined product, then the receiving chambers can be filled simultaneously or also sequentially. The stepwise filling of the receiving chamber with an inventive detergent or cleaning agent that includes a dispersion and one or more powders, is here particularly preferred. If dispersion and powder are filled into the same receiving chamber, then in this way fixed layer structures can be easily prepared, their multiphase aspect being optically highlighted, for example by the addition of appropriate colorants. Such multilayer receiving chambers can have two, three, four, five or more individual layers. The resulting water-soluble packaged multilayer detergents or cleaning agents stand out because of the high density of the inventive dispersions compared with comparable densities of detergent or cleaning agent tablets, and furthermore dissolve markedly faster as no compression pressures were used in their preparation. Some examples of particularly preferred embodiments of these multiphase receiving chambers having up to five layers are shown in the following Table:

Water-soluble or water-dispersible receiving chambers with two or three layer filling:

| Layer 1 | Layer 2 | Layer 3 |
|---|---|---|
| Dispersion | Solid 1 | — |
| Dispersion | Dispersion 2 | |
| Dispersion | Solid 1 | Solid 2 |
| Solid 1 | Dispersion | Solid 1 |
| Solid 1 | Dispersion | Solid 2 |
| Dispersion | Liquid 1 | — |
| Solid 1 | Dispersion | Liquid 1 |
| Dispersion | Solid 1 | Dispersion 2 |
| Dispersion | Dispersion 2 | Solid 1 |
| Dispersion | Liquid 1 | Dispersion 2 |

When one or more dispersion(s) according to the previously described embodiments is/are combined with additional solids and/or liquids to form a detergent or cleaning agent, then the content by weight of the inventive dispersion(s) to the total weight of the resulting detergent or cleaning agent (disregarding an optional water-soluble or water-dispersible packaging) is advantageously between 5 and 95 wt. %, preferably between 7 and 80 wt. %. particularly preferably between 9 and 65 wt. % and in particular between 11 and 53 wt. %.

In a preferred embodiment of the present invention the first active detergent or cleaning composition in the water-soluble or water-dispersible packaging is separated, at least partially, from a second active detergent or cleaning composition.

The manufacture of water-soluble or water-dispersible packaging using forming processes to transform the external coating materials suitably employs deep drawing processes, injection molding processes or casting processes.

The “deep drawing” process, in the context of the present application, involves processes, in which a first film of coating material after being placed over a receiving cavity in a deep-drawing mold is molded by the action of pressure and/or vacuum. The external coating material can be treated before or during the shaping by the action of heat and/or solvents and/or conditioning by relative humidities and/or temperatures, modified with respect to the surrounding conditions. The application of pressure can occur by means of two parts of a tool, which fit positively and negatively with each other and shape the film brought between these tools by being pressed together. The use of compressed air and/or the inherent weight of the film and/or the inherent weight of an active substance placed on the upper side of the film, is/are also suitable as pressure forces.

After the deep drawing, the deep drawn external coating materials are preferably fixed in their deep drawn shape by applying a vacuum inside the receiving cavity. The vacuum is preferably applied continuously from deep drawing to filling, preferably to sealing and particularly to the separation from the receiving chamber. It is also possible to apply a discontinuous vacuum, for example up to the deep drawing of the receiving chambers and (after a pause) before and during the filling of the receiving chamber. The continuous or discontinuous vacuum can also vary in strength; for example at the beginning of the process (deep drawing of the film), higher values can be applied than at the end (filling or sealing or separation).

As already mentioned, the external coating material can be treated prior to or during the shaping into the receiving cavity of the mold by the action of heat. Thus the external coating material, preferably a water-soluble or water-dispersible polymer film, is heated for up to 5 seconds, advantageously for 0.1 to 4 seconds, particularly preferably for 0.2 to 3 seconds and in particular for 0.4 to 2 seconds to a temperature above 60° C., advantageously above 80° C., particularly preferably between 100 and 120° C. and in particular to temperatures between 105 and 115° C. To dissipate this heat, but particularly to also dissipate the heat brought into the receiving chamber by the deep drawn product (e.g. melts), it is preferred to cool the matrix and the receiving cavity in this matrix. They are advantageously cooled down to temperatures below 20° C., preferably below 15° C., particularly preferably to temperatures between 2 and 14° C. and in particular to temperatures between 4 and 12° C. Preferably, the cooling is continuous from the start of the deep drawing process to the sealing and separation from the receiving chamber. Liquid coolants are particularly suitable for cooling; preferably water, which is circulated inside the matrix by means of special cooling ducts.

This cooling, like the previously described, continuous or discontinuous application of a vacuum, has the advantage of preventing a shrink-back of the deep drawn containers, whereby not only the optical properties of the product is improved, but also the material, filled in the receiving chamber, is simultaneously prevented from escaping past the edge of the receiving chamber, e.g. into the sealing area of the chamber. Sealing problems with filled chambers are thus avoided.

The deep drawing process can be sub-divided into two methods, one in which the external coating material is fed horizontally in a mold and from there fed horizontally to filling and/or sealing and/or removal, and processes, in which the external coating material is fed over a continuously circulating matrix shaping roll (optionally with a counter-running stamping shaping roll, which leads the upper shaping stamps into the cavities of the matrices' shaping roll). The first mentioned process variant, the flatbed process, is driven both continuously and discontinuously, the second process variant with the shaping rolls is usually continuous. All known deep drawing processes are suitable for manufacturing the preferred agents according to the invention. The receiving cavities in the matrices can be arranged “in line” or offset.

A further preferred process used for manufacturing the inventive water-soluble or water-dispersible containers, is injection molding. Injection-molding means converting a molding material in such a way that material required for more than one injection cycle is heated in a barrel to soften it and is then introduced, under pressure, through a nozzle into the cavity of an already closed mold. The process is principally used for non-crosslinkable molding materials, which cool down in the mold and solidify. Injection molding is a very efficient modern process for manufacturing non-cut objects and is particularly suitable for automated mass-production. In practical operation, the thermoplastic molding materials (powder, pellets, diced forms, pastes, inter alia) are heated until liquid (to 180° C.) and injected under high pressure (up to 140 MPa) into a preferably water-cooled closed, two-piece mold, consisting of a cavity (earlier a matrix) and core (earlier stamp), where they cool and solidify. Plunger and screw injection molding machines are suitable. Water-soluble polymers, such as the above-mentioned cellulose ethers, pectins, polyethylene glycols, polyvinyl alcohols, polyvinyl pyrrolidones, alginates, gelatines or starches are suitable molding materials (injection molding materials).

However, the external coating materials can also be cast into moldings. The molding of the resulting inventive preferred water-soluble or water-dispersible portioned agent includes at least one solidified melt. This melt can be a molten pure substance or a mixture of several substances. Naturally, it is possible to mix the individual substances before melting into a multi-substance melt, or to prepare separate melts, which are then combined. Melts of mixtures of substances can be advantageous, e.g. if eutectic mixtures form, which melt much lower and therefore reduce process costs.

Preferred inventive portioned agents are characterized in that the molding consists of at least one material or mixture of materials, whose melting point lies in the range 40 to 1000° C., preferably 42.5° C. to 500° C., particularly preferably from 45 to 200° C. and in particular from 50 to 160° C.

Preferably, the material of the melt has a high water-solubility that for example is above 100 g/l, solubilities in distilled water at 20° C. of greater than 200 g/l being particularly preferred.

Such materials originate from the most varied groups of substances. In the context of the present invention as materials for the moldings, those melts have proven particularly suitable that originate from the groups of from carboxylic acids, carboxylic acid anhydrides, dicarboxylic acids, dicarboxylic acid anhydrides, hydrogen carbonates, hydrogen sulfates, polyethylene glycols, polypropylene glycols, sodium acetate-trihydrate and/or urea. Inventive portioned agents are particularly preferred, in which the material of the molding includes one or several materials from the groups of carboxylic acids, carboxylic acid anhydrides, dicarboxylic acids, dicarboxylic acid anhydrides, hydrogen carbonates, hydrogen sulfates, polyethylene glycols, polypropylene glycols sodium acetate-trihydrate and/or urea in amounts of at least 40 wt. %, advantageously at least 60 wt. % and in particular at least 80 wt. %, each based on the weight of the molding.

Besides dicarboxylic acids, carboxylic acids and their salts are suitable materials for the manufacture of open moldings. From this class of materials, citric acid and trisodium citrate as well as salicylic acid and glycolic acid have proven particularly suitable. Also, fatty acids, preferably having more than 10 carbon atoms, and their salts can be used with particular advantage material for the open molding. In the context of the present invention, exemplary, suitable fatty acids are hexanoic acid (caproic acid), heptanoic acid (enanthic acid), octanoic acid (caprylic acid), nonanoic acid (pelargonic acid), decanoic acid (caprinic acid), undecanoic acid etc. In the context of the present invention, preferred fatty acids are dodecanoic acid (lauric acid), tetradecanoic acid (myristic acid), hexadecanoic acid (palmitic acid), octadecanoic acid (stearic acid), eicosanoic acid (arachic acid), docosanoic acid (behenic acid), tetracosanoic acid (lignoceric acid), hexacosanoic acid (cerotic acid), triacotanoic acid (melissic acid) as well as the unsaturated series 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid). For reasons of cost, it is preferred not to use the pure species but rather technical mixtures of the individual acids, just as they are obtained by fat cleavage. Such mixtures are, for example coconut oil fatty acid (about 6% by weight C8, 6% by weight C10, 48% by weight C12, 18% by weight C14, 10% by weight C16, 2% by weight C18, 8% by weight C18′, 1% by weight C8″), palm kernel oil fatty acid (about 4% by weight C8, 5% by weight C10, 50% by weight C12, 15% by weight C14, 7% by weight C16, 2% by weight C18, 15% by weight C18′, 1% by weight C18″), tallow fatty acid (about 3% by weight C14, 26% by weight C16, 2% by weight C16′, 2% by weight C17, 17% by weight C18, 44% by weight C18′, 3% by weight C18″, 1% by weight C18′″), hydrogenated tallow fatty acid (about 2% by weight C14, 28% by weight C16, 2% by weight C17, 63% by weight C18, 1% by weight C18′), technical-grade oleic acid (about 1% by weight C12, 3% by weight C14, 5% by weight C16, 6% by weight C16′, 1% by weight C17, 2% by weight C18, 70% by weight C18′, 10% by weight C18″, 0.5% by weight C18′″), technical-grade palmitic/stearic acid (about 1% by weight C12, 2% by weight C14, 45% by weight C16, 2% by weight C17, 47% by weight C18, 1% by weight C18′), and soybean oil fatty acid (about 2% by weight C14, 15% by weight C16, 5% by weight C18, 25% by weight C18′, 45% by weight C18″, 7% by weight C18′″).

The above-cited carboxylic acids are for the most part obtained industrially by hydrolysis of natural fats and oils. While the alkaline saponification process, already used in the previous century led to the alkali salts (soaps), today industrially, only water is used to cleave the fats into glycerine and free fatty acids. Industrially practiced processessare e.g. cleavage in autoclaves or continuous high-pressure cleavage. The alkali metal salts of the above cited carboxylic acids or mixtures of carboxylic acids can also be used—optionally mixed with other materials—for the manufacture of open moldings. Salicylic acid and/or acetylsalicylic acid or their salts, preferably their alkali metal salts are also suitable, for example.

Further suitable materials, which can be converted in the melt state to open moldings are hydrogen carbonates, particularly the alkali metal hydrogen carbonates, specifically sodium and potassium hydrogen carbonates, as well as the hydrogen sulfates, particularly alkali metal hydrogen sulfates, specifically potassium and/or sodium hydrogen sulfate. The eutectic mixture of potassium hydrogen sulfate and sodium hydrogen sulfate, consisting of 60 wt. % NaHSO₄ and 40% KHSO₄, has also proved to be particularly suitable.

Further particularly suitable melt materials are to be found in the following table:

| | Melting | Solubility |
|---|---|---|
| | point [° C.] | [g/l H₂O] |
| Ammonium aluminium sulfate-dodecahydrate | 93 | 150 |
| Potassium aluminium sulfate-dodecahydrate | 92 | 110 |
| Aluminium sulfate-monohydrate | 90 | 600 |
| Aluminium sulfate-octadecahydrate | 90 | 600 |
| Sodium phosphinate monohydrate | 90 | 1000 |
| Sodium dihydrogen phosphate | 100 | 1103 |
| Sodium dihydrogen phosphate monohydrate | 100 | 1103 |
| Sodium ammonium hydrogen phosphate | 79 | 167 |
| tetrahydrate | | |
| Disodium hydrogen phosphate heptahydrate | 48 | 154 |
| Trisodium phosphate dodecahydrate | 75 | 258 |
| Tri potassium phosphate heptahydrate | 46 | 900 |
| Ammonium iron (II) sulfate hexahydrate | 100 | 269 |
| Iron sulfate heptahydrate | 64 | 400 |
| Glucose | 83 | 820 |
| Magnesium acetate-tetrahydrate | 80 | 1200 |
| Manganese (II) chloride-tetrahydrate | 58 | 1980 |
| Sodium acetate-trihydrate | 58 | 762 |
| Sodium hydrogen sulfate monohydrate | 58 | 670 |
| Sodium carbonate peroxohydrate | 60 | 150 |
| Sodium thiosulfate pentahydrate | 48 | 680 |
| Potassium sodium tartrate tetrahydrate | 70-80 | 630 |
| D(+)-Glucose-monohydrate | 83 | 820 |
| Zinc acetate-dihydrate | 100 | 430 |
| Zinc sulfate-heptahydrate | 40 | 960 |

As can be seen from the table, sugars are also suitable materials for the melt. Consequently, further preferred are also agents, which are characterized in that the material of the molding includes one or several materials from the group of sugars and/or sugar acids and/or sugar alcohols, advantageously from the group of sugars, particularly preferably from the group of oligosaccharides, oligosaccharide derivatives, monosaccharides, disaccharides, monosaccharide derivatives and disaccharide derivatives as well as their mixtures, particularly from the group glucose and/or fructose and/or ribose and/or maltose and/or lactose and/or saccharose and/or maltodextrin and/or Isomalt®.

In the context of the present invention, the sugars, sugar acids and sugar alcohols have proven particularly suitable materials for the melts. In general, these substances are not only extremely soluble, but also distinguish themselves by low costs and good processability. Thus, the sugars and sugar derivatives, particularly the mono and disaccharides and their derivatives can be processed, for example in the form of their melts, these melts exhibiting a good solvation capability both for colorants and also many active detergents and cleaning substances. The solids resulting from the solidification of the sugar melts are also distinguished by their smooth surface and an advantageous optical appearance, such as a high surface gloss or transparency.

In the context of the present application, the preferred sugars as melt materials belong to the group of mono and disaccharides and derivatives of mono and disaccharides, particularly glucose, fructose, ribose, maltose, lactose, saccharose, maltodextrin and Isomalt® as well as mixtures of two, three, four or more mono and/or disaccharides and/or the derivatives of mono and/or disaccharides. Thus, mixtures of Isomalt® and glucose, Isomalt® and lactose, Isomalt® and fructose, Isomalt® and ribose, Isomalt® and maltose, glucose and saccharose, Isomalt® and maltodextrin or Isomalt® and saccharose are particularly preferred as materials for the melt. The weight content of Isomalt° to the total weight of the above cited mixtures is advantageously less than 20 wt. %, particularly preferably at least 40 wt. % and in particular at least 80 wt. %.

Further particularly preferred materials for the melt are mixtures of maltodextrin and glucose, maltodextrin and lactose, maltodextrin and fructose, maltodextrin and ribose, maltodextrin and maltose or maltodextrin and saccharose. The proportion by weight of the maltodextrin to the total weight of the above-cited mixtures is advantageously at least 20 wt. %, particularly preferably at least 40 wt. % and in particular at least 80 wt. %.

In the context of the present application, maltodextrins are understood to mean water-soluble carbohydrates (dextrose equivalent, DE 3-20) with a chain length of 5-10 anhydroglucose units and a high maltose content, obtained by enzymatic degradation of starch. Maltodextrins are added to foodstuffs to improve the rheological and caloric properties, taste only slightly sweet and do not tend to retrogradation. Commercial products, for example from Cerestar Company, are generally offered as spray-dried free-flowing powders and have a water content of 3 to 5 wt. %.

In the context of the present application, Isomalt® is understood to mean a mixture of 6-O-a-D-glucopyranosyl-D-sorbitol (1,6-GPS) and 1-O-a-D-glucopyranosyl-D-mannitol (1,1-GPM). In a preferred embodiment, the weight content of 1,6-GPS based on the total weight of the mixture is less than 57 wt. %. These types of mixtures can be manufactured industrially, for example, by enzymatic rearrangement of saccharose into isomaltose, which is subsequently hydrogenated to afford an odorless, colorless and crystalline solid.

The subject of the present invention in a further preferred embodiment, is a inventive detergent or cleaning agent that is at least partially enclosed by a molding of at least one solidified melt. Such moldings are particularly preferred, which include at least one further solid, the at least one further solid being at least partially cast into the wall of the molding.

In the context of the present invention, the term “molding” signifies at least one shape that encloses a space, such that the enclosing space can be or is filled. Besides the at least one enclosed space, the molding can have additional spaces and/or not completely enclosed spaces. In the context of the present invention, the molding does not need to consist of a uniform wall material, but can also be composed of a plurality of different materials.

The inclusion of at least one solid in the wall of the molding is possible, for example, in that a concave hollow is produced from a solidified melt, which encloses at least one solid at least partially. This concave hollow can subsequently be filled and—for example, be closed by a melt of a different composition. Both the solidified melts together form the molding of the inventive preferred agent. (0334] Analogously, at least one solid can also be at least partially incorporated into the melt, which seals the concave hollow made from solidified melt. Again, the concave hollow of solidified melt and the solidified melt, which forms the “lid,” together form the molding of the inventive agent. In this embodiment, the concave hollow can enclose at least one solid at least partially (then the molding comprises at least two solids); it can, however, be completely free of a solid, as the enclosed solid, which is at least partially enclosed by the sealing melt is present at least partially cast into the wall of the mold.

The preferred portioned agents according to the invention include a molding. This can be a concave hollow, for example, which is designed to incorporate the inventive dispersion and can be optionally sealed. However, it is also possible (see above) to manufacture a concave hollow without an included solid, and at least partially set a solid into a molding sealed with the solidified melt. At least one additional solid is at least partially cast into the wall of this molding. In the context of the present invention, “solid” means that the solid does not itself melt at the melt temperature of the melt and also do not dissolve in the melt. During processing to the inventive portioned agents, the melts, prior to cooling, are therefore present as flowable material together with solids. After the melt has cooled, the solids still constitute discrete areas of the wall of the molding, the total molding is however naturally solid.

Preferred inventive detergents or cleaning agents are characterized in that the water-soluble or water-dispersible packaging was manufactured, at least partially, by deep drawing or injection molding or casting.

As already mentioned further above, preferred water-soluble or water-dispersible containers are characterized by an at least partially locking closure for the water-soluble or water-dispersible container. These types of closures can be fitted on the water-soluble or water-dispersible container, particularly the deep drawn body, the injection molded body or the cast body, by means of various processes.

In the context of the present application, such agents are particularly preferred, whose water-soluble or water-dispersible container is joined to the water-soluble or water-dispersible closure by means of an adhesive.

In the context of this application, all substances or mixtures of substances known to the expert for this purpose, may be used as the adhesive. However, water-soluble or water-dispersible polymers or their mixtures or solutions, particularly aqueous solutions of these water-soluble or water-dispersible polymers or solutions, particularly aqueous solutions of these mixtures, are particularly suitable and particularly preferred in the context of the present application. Aqueous solutions of polyvinyl alcohol, polyvinyl pyrrolidone, polyethylene oxides, gelatin or polymers from the group of starches and starch derivatives, cellulose and Cellulose derivatives, particularly methyl cellulose are particularly preferred.

Further preferred are water-soluble hot melt adhesives, particularly hot melt adhesives, which comprise
a) 40 to 70 wt. % of at least one homo or copolymer based on ethylenically unsaturated monomers with free carboxylic acid groups (component A),
b) 15 to 45 wt. % of at least one water-soluble or water-dispersible polyurethane (component B), and
c) 10 to 45 wt. % of at least one inorganic or organic base (component C),
d) tpgether with 0 to 20 wt. % of additional additives, the sum of the components making 100 wt. %.

Finally, however, pure solvents, particularly water, or solutions of inorganic or organic salts, particularly aqueous solutions of inorganic or organic salts, are suitable as adhesives and are preferred in the context of the present application.

The adhesion process for the deep drawn bodies, injection molded bodies or cast bodies can be widely varied depending on the production requirements. Below, it is intended to describe a particularly preferred process to adhere water-soluble or water-dispersible containers, particularly water-soluble or water-dispersible deep drawn bodies, injection molded bodies or cast bodies to water-soluble or water-dispersible closures.

In a first preferred process to manufacture made-up inventive dispersions,
a) a water-soluble or water-dispersible deep drawn body or injection molded body filled with an inventive dispersion, or a cast body made of an inventive dispersion, preferably a cast body filled with one or a plurality of further substances or mixtures of substances;
b) is applied with an adhesive; and
c) is adhesively sealed by a water-soluble or water-dispersible closure.

In a further preferred embodiment of this process, the application of the adhesive in step b) is carried out by a roller, a moving conveyor belt, a spraying device or a stamp.

In preferred process variants, closures of water-soluble or water-dispersible polymers are used for the closure in step c), wherein rolls of film or prefabricated sealing etiquettes can be used.

In a second preferred process to manufacture made-up inventive dispersions,
a) a water-soluble or water-dispersible deep drawn body or injection molded body filled with an inventive dispersion, or a cast body made of an inventive dispersion, preferably a cast body filled with one or a plurality of further substances or mixtures of substances;
b) is adhesively sealed by a water-soluble or water-dispersible closure; and
c) was previously applied with an adhesive

It is again preferred to apply the adhesive by means of a roller, a moving conveyor belt, a spraying device or a stamp, wherein for this process, it is particularly preferred not to do this over the whole surface of the closure, but exclusively on the areas that will actually adhere to the surface of the corresponding body. Closures made from water-soluble or water-dispersible polymers are also preferred for use here, particularly in the form of rolls of film or prefabricated closures.

In the above-described process, if closures are used that do not exactly fit when sealing the corresponding body (e.g. rolls of film), then after adhesion, these closures have to be cut to their final size. In the context of the present application, this process step is preferably carried out using knives and/or punches and/or lasers.

In summary, in the context of the present application a particularly preferred process for making-up the inventive dispersions is used, in which
a) a detergent or cleaning agent in the form of a dispersion of solid particles in a dispersion agent, which, based on its total weight, includes
   i) 10 to 65 wt. % dispersion agent and
   ii) 30 to 90 wt. % dispersed material, wherein the dispersion has a density of more than 1.040 g/cm³ and is cast to a cast body having a receiving chamber;
b) the receiving chamber is filled with at least one active detergent or cleaning substance;
c) the filled receiving chamber is adhesively sealed with a water-soluble or water-dispersible closure;
d) whereby the appropriate adhesive was previously applied to the cast body and/or the closure by means of a roller, a moving conveyor belt, a spraying device or a stamp.

As previously described, the preferred deep drawn or injection molded bodies for the inventive dispersions or the closures for the deep drawn, injection molded or cast bodies are water-soluble or water-dispersible. In the context of the present application, preferred inventive agents are therefore manufactured, in which the corresponding bodies or the corresponding closures have at least one water-soluble or water-dispersible external coating material. Accordingly, those inventive agents, whose external coating material includes a water-soluble or water-dispersible polymer, are particularly preferred.

Particularly preferred agents are characterized in that they include at least two different external coating materials with different dissolution behavior, wherein preferably they differ from each other due to their chemical composition. The dissolution behavior of the deep drawn, injection molded or cast bodies and the closure used to seal the body, can not only be influenced by the chemical composition of the external coating material, but also, for example, by the thickness of the container walls of the deep drawn, injection molded or cast bodies or the walls of the closure. In the context of the present application, preferred deep drawn, injection molded or cast bodies are characterized in that the side walls of the receiving chambers made of the first external coating material have a thickness of 5 to 2000 μm, advantageously 10 to 1000 μm, particularly preferably 15 to 500 μm, quite particularly preferably 20 to 200 μm and in particular 25 to 100 μm. Preferred cast bodies, on the other hand, are characterized in that the wall thickness of the cast bodies, in so far that they have a receiving chamber, range between 0.1 and 25 mm, advantageously between 0.5 and 20 mm and in particular between 1 and 15 mm. The closure used for sealing, preferably has a thickness of 5 to 100 μm, particularly preferably 6 to 80 μm and in particular 7 to 50 μm. It is particularly preferred that deep drawn, injection molded or cast bodies and closures have different thicknesses, wherein such deep drawn, injection molded or cast bodies are advantageous when their wall thickness is larger than the wall thickness of the corresponding closure.

As can be inferred from the previous statements, these preferred inventive agents are suited in a particular way for the controlled release of the contained active substances, particularly the active substances from the group of detergents or cleaning agents.

Consequently, a preferred embodiment according to the invention is when the deep drawn, injection molded or cast body is fully water-soluble, i.e. according to the intended use in washing or automatic cleaning, completely dissolves, when the intended conditions for dissolution are attained. A marked advantage of this embodiment is that the deep drawn, injection molded or cast bodies at least partially dissolve under exactly defined conditions in the wash liquor in a practically relevant short time—as a non-limiting example, within some seconds to 5 minutes—and depending on the requirements of the enclosed contents, i.e. the active cleaning material or materials, releases them into the water. This release can now be controlled or directed in various ways.

In a first, and due to the advantageous properties, particularly preferred embodiment of the invention, the water-soluble deep drawn, injection molded or cast body includes lower or completely water-insoluble regions, or regions that are water-soluble only at higher temperature and good water-soluble regions or regions water-soluble only at lower temperatures. In other words: The body does not consist of a uniform material exhibiting the same water-solubility, but rather consists of materials exhibiting different water-solubilities. Areas of good water-solubility are firstly to be differentiated from those of less good water-solubility, of poorer or even no water-solubility, or secondly, from areas, in which the water-solubility first attains the desired value only at higher temperature or first at another pH, or first at a modified electrolyte concentration. Under adjustable conditions of intended use, this can lead to specific areas of the deep drawn, injection molded or cast bodies dissolving, whilst other areas remain intact. Thus, a body with pores or holes can be imagined, into which water and/or liquor infiltrate, dissolve the active detergent, rinse or cleaning ingredients and drain out of the body. In the same way, systems in the form of multi-chamber deep drawn, injection molded or cast bodies or in the form of concentrically layered bodies (“onion system”) can be designed. In this manner, systems with controlled-released active detergent, active rinse or active cleaning ingredients can be manufactured.

The invention is not subject to any limitations in the construction of this type of system. Thus, containers are provided, in which a uniform polymer material includes small areas of built in compounds (salts, for example), which dissolve faster in water than the polymeric material. On the other hand, a plurality of polymeric materials with different water-solubilities can be mixed (polymer blend), such that the faster dissolving polymeric material is disintegrated faster under defined conditions by water or the liquor than the slower dissolving material.

In a particularly preferred embodiment of the invention, the lower or completely water-insoluble regions, or regions that are water-soluble only at higher temperature of the deep drawn, injection molded bodies are of one material that chemically, essentially corresponds to that of good water-soluble regions or regions water-soluble only at lower temperatures, however, have a thicker layer and/or a modified degree of polymerization from the same polymers and/or a higher degree of crosslinking of the same polymer structure and/or a higher degree of acetalization (for PVAL, for example with saccharides, polysaccharides like starch) and/or a content of water-insoluble salt components and/or a content of water-insoluble polymers. Even taking into consideration the fact that the container does not completely dissolve, according to the invention, such portioned detergent and cleaning agent compositions can be prepared, which exhibit the advantageous properties when releasing the active substances into the liquors, particularly active substances from the group of detergent or cleaning agents.

Besides this controlled release, made possible by the judicious choice of the external coating materials used, there are however, even more processing techniques available to the expert. An alternative approach, which can be suitably used alone or in combination with the previously-cited control by choosing specific external coating materials for controlled release of active substances or mixtures of active substances, is the integration of one or more “switches” into the above-mentioned active substances, mixtures of active substances or preparations of active substances.

In particularly preferred embodiments, possible “switches” that influence the dissolution behavior of the active substances enclosed in the inventive deep drawn, injection molded or cast bodies, are physico-chemical parameters. Examples of these, which, however are not intended to be understood as limiting, are
the mechanical stability, for example of an optionally added capsule, coating or an optionally added compacted body, such as a tablet, which—depending on the time, on the temperature or on other parameters—can be one of the determining factors for the disintegration;
the solubility of the optionally added capsules or coatings or matrices as a function of the pH and/or temperature and/or ionic strength;
the rate of dissolution of optionally added capsules or coatings or matrices as a function of the pH and/or temperature and/or ionic strength;
the melting behavior of optionally added capsules or coatings or matrices as a function of the pH and/or temperature and/or ionic strength.

In a particularly preferred embodiment, the inventive deep drawn, injection molded or cast body includes at least one active substance or active substance preparation whose release is delayed. Accordingly, the delayed release results advantageously from the use of at least one of the above-cited agents, in particular, however from the use of different packaging materials and/or the use of selected coating materials, wherein it is particularly important that this delayed release for active substances or mixtures of active substances from the group of detergents or cleaning agents happens not before 5 minutes, preferably not before 7 minutes, particularly not before 10 minutes, quite particularly preferably not before 15 minutes and in particular not before 20 minutes after the start of the cleaning or washing process. For this, the addition of meltable coating materials from the group of waxes and paraffins is particularly preferred.

Active substances, which are subject to a delayed release with particular advantage, are the fragrances, the polymers, the surfactants, the bleaching agents and the bleach activators. However, fragrances and/or surfactants are preferred to be released with a delay.

In the context of the present application particularly preferred are therefore detergents or cleaning agent cast bodies, comprising a first active detergent or cleaning preparation in the form of a dispersion of solid particles in a dispersion agent, which, based on its total weight, includes
a) 10 to 65 wt. % dispersion agent and
b) 30 to 90 wt. % dispersed material,
   wherein the detergent or cleaning agent comprises at least an additional active detergent or cleaning preparation that dissolves faster in water at 40° C. than the first active detergent or cleaning preparation, the cast body having a receiving chamber or cavity, which is at least partially filled with a cleaning agent component, which includes
c) 5 to 95 wt. % surfactant as well as
d) 5 to 95 wt. % meltable substance(s) having a melting point above 30° C. and a water-solubility of less than 20 g/l at 20° C.
e) together with optionally additional ingredients of detergents or cleaning agents.

Particularly preferred cast bodies are those in which the ingredient c) are non-ionic surfactants, advantageously non-ionic surfactant(s) with a melting point above 20° C., preferably above 25° C., particularly preferably between 25 and 60° C. and, in particular between 26.6 and 43.3° C.

Suitable non-ionic surfactants are particularly:
ethoxylated non-ionic surfactant(s) prepared from C6-20-monohydroxy alkanols or C6-20-alkyl phenols or C12-20-fatty alcohols and more than 12 mole, preferably more than 15 mole and in particular more than 20 mole ethylene oxide per mole alcohol,
ethoxylated and propoxylated non-ionic surfactants, in which the propylene oxide units in the molecule preferably make up as much as 25% by weight, preferably as much as 20% by weight and, in particular up to 15% by weight of the total molecular weight of the non-ionic surfactant,
non-ionic surfactants that satisfy the formula
   R¹O[CH₂CH(CH₃)O]ₓ[CH₂CH₂O]_{y}[CH₂CH(OH)R²],
   in which R¹ stands for a linear or branched aliphatic hydrocarbon radical with 4 to 18 carbon atoms or mixtures thereof, R² means a linear or branched hydrocarbon radical with 2 to 26 carbon atoms or mixtures thereof and x stands for values between 0.5 and 1.5 and y stands for a value of at least 15.
end capped poly(oxyalkylated) non-ionic surfactants of formula
   R¹O[CH₂CH(R³)O]ₓ[CH₂]ₖCH(OH)[CH₂]ⱼOR²
   in which R¹ and R² stand for linear or branched, saturated or unsaturated, aliphatic or aromatic hydrocarbon radicals with 1 to 30 carbon atoms, R³ stands for H or for a methyl, ethyl, n-propyl, isopropyl, n-butyl, 1-butyl or 2-methyl-2-butyl radical, x has a value between 1 and 30, k and j have values between 1 and 12, preferably 1 to 5, wherein surfactants of the type
   R¹O[CH₂CH(R³)O]ₓCH₂CH(OH)CH₂OR²
   in which x stands for numbers from 1 to 30, preferably 1 to 20 and in particular 6 to 18, are particularly preferred.
polyalkoxylated non-ionic surfactants of the general formula
   R¹O[EO]ₓ[PO]_{y}[BO]_{z},
   in which R¹ stands for linear or branched, saturated or unsaturated, aliphatic or aromatic hydrocarbon radicals with 6 to 20 carbon atoms, x has a value between 2 and 30, y for values between 0 and 30 and z for values between 1 and 30;
non-ionic surfactants of the general formula
   R¹O[CH₂CH(R³)O]ₓR²
   in which R¹ stands for linear or branched, saturated or unsaturated, aliphatic or aromatic hydrocarbon radicals with 1 to 30 carbon atoms, R² for linear or branched, saturated or unsaturated, aliphatic or aromatic hydrocarbon radicals with 1 to 30 carbon atoms, which have 1 to 5, preferably 1 hydroxy group, R³ stands for H or for a methyl, ethyl, n-propyl, isopropyl, n-butyl, 1-butyl or 2-methyl-2-butyl radical, x has a value between 1 and 30.

Ingredient d) is advantageously one or more materials with a melting range between 30 and 100° C., preferably between 40 and 80° C. and in particular between 50 and 75° C., wherein the ingredient b) particularly preferably comprises at least one paraffin with a melting range from 30 to 65° C. Further preferred ingredients d) are the waxes and/or fat(s) and/or triglyceride(s) and/or fatty acids and/or fatty alcohols described further above.

The water-solubility at 20° C. of the ingredient d) is advantageously less than 15 g/l, preferably less than 10 g/l, particularly preferably less than 5 g/l and in particular less than 2 g/l.

The previously described cast bodies with a filled receiving chamber or cavity can, for example, look like two- or multiphase core tablets or two or multiphase circular tablets, known to the expert, without actually having been subject to tableting.

A further preferred process for making up the inventive detergents or cleaning agents is to process the dispersions to shape-stable bodies having receiving cavities or to moldings and to fill this cavity or hollow space with the additional active detergent or cleaning preparation. The resulting combination products can additionally possess a water-soluble or water-dispersible packaging. In the context of the present application, detergents or cleaning agents are therefore further preferred, wherein the first active detergent or cleaning preparation forms a hollow body, in the cavity of which the additional active detergent or cleaning preparation is at least partially included.

A further preferred process for making up the inventive detergents or cleaning agents is to process the dispersions to shape-stable bodies having receiving cavities or to moldings and to fill this cavity or hollow space with the additional preparation of active detergent or cleaning agent. The resulting combined products can additionally possess a water-soluble or water-dispersible packaging. In the context of the present application, detergents or cleaning agents are therefore further preferred, wherein the first active detergent or cleaning preparation forms a hollow body, in the cavity of which the additional active detergent or cleaning preparation is at least partially included.

With regard to an increased sedimentation stability, it is preferred that the dispersed materials in the inventive agents are as fine as possible. This is particularly advantageous for the polymers, the builders, the inorganic thickeners and for the bleaching agents. According to the invention, automatic dishwasher agents are preferred in which the average particle size of the polymers, builders, thickeners or bleaching agents is less than 75 μm, advantageously less than 50 μm and in particular, less than 25 μm. Inventive agents are particularly preferred, in which at least 50 wt. %, preferably at least 60 wt. %, particularly preferably at least 75 wt. % and in particular preferably at least 90 wt. % of the dispersed polymers and/or builders and/or bleaching agents have a particle size below 90 μm, advantageously below 80 μm, preferably below 70 μm, particularly preferably below 60 μm and in particular below 50 μm.

A dispersed material or the dispersions can be ground in order to achieve this type of particle size. Both dry grinding as well as wet grinding are suitable for grinding. The dry grinding can be carried out in all types of mills known from the prior art, wherein disk mills, impact mills and air stream mills are given merely as examples. The grinding is particularly preferably made in an impact mill or air stream mill. For the particularly preferred wet grinding, also all types of mills known from the prior art can be used, wherein for example mention should be made of ball mills, rolling mill, container mills and in-line dispersion mixers. The wet grinding is carried out with particular advantage in a rolling mill.

A further subject of the present invention is a process for cleaning dishes in a dishwasher, whereby an inventive detergent or cleaning agent is placed in the dosing chamber or the interior of the dishwasher before the cleaning cycle.

### EXAMPLES

Two cleaning agents were prepared with compositions V1 and E1. The ingredients of cleaning agent V1 were pressed into tablets. The preparation of cleaning agent E1 was carried out by kneading a part of the STTP, the non-ionic surfactant, the bleach activator, the polyacrylate, the glass corrosion protection agent, the silver protection agent and the dispersion agent into a dispersion, the other ingredients were mixed to a powder. This powder, together with the dispersion form the inventive agent E1, The density of the dispersion was 1.37 g/cm³.

TABLE 1
Composition of the premixes [weight contents]:

| | V1 | E1 | E1 Dispersion | E1 Powder |
|---|---|---|---|---|
| STTP | 57.0 | 57.0 | 15.0 | 42.0 |
| Non-ionic Surfactant | 12.5 | 12.5 | 12.5 | |
| Sodium carbonate | 6.0 | 6.0 | | 6.0 |
| Bleaching agent | 7.0 | 7.0 | | 7.0 |
| Bleach activator²⁾ | 0.5 | 0.5 | 0.5 | |
| Polyacrylate³⁾ | 10.0 | 10.0 | 10.0 | |
| Sodium silicate | 2.0 | 2.0 | | 2.0 |
| Colorant | 0.5 | 0.5 | | 0.5 |
| Enzyme⁴⁾ | 3.0 | 3.0 | | 3.0 |
| Glass corrosion protection | 1.0 | 1.0 | 1.0 | |
| agent⁵⁾ | | | | |
| Silver protection agent | 0.5 | 0.5 | 0.5 | |
| Dispersion agent⁷⁾ | | 8.0 | 8.0 | |

¹⁾Percarbonate
²⁾TAED
³⁾Acrylic acid-sulfonic acid copolymer
⁴⁾Protease, Amylase
⁵⁾Zinc acetate
⁶⁾Manganese sulfate
⁷⁾PEG 3000

Dissolution Behavior

For the determination of the solubility, 20 g of each of the comparison V1, the combination product E1, the dispersion (E1 dispersion) or the powder (E1 powder) was placed in inside a dishwasher (Miele G 646 PLUS). The main cleaning cycle of a standard cleaning program (45° C.) is started. The solubility determination is made by measuring the conductivity, displayed using a conductivity sensor. The dissolving process ends at the conductivity maximum. This maximum corresponds to a plateau in the conductivity diagram. The conductivity measurement begins when the circulation pump in the main cleaning cycle switches on. The results are presented in Table 2.

TABLE 2
Dissolution times:

| | | | E1 | |
|---|---|---|---|---|
| | V1 | E1 | Dispersion | E1 Powder |
| Dissolution time | 18 | 6 | 6 | 4, 5 |
| (minutes) | | | | |

Cleaning Performance

Standardized dirty dishes (milk, burnt mincemeat, egg yolk, starch) were subjected to a cleaning cycle at 40° C. in an automatic dishwasher (Bosch 5302). 25 g of the cleaning agent V1 and E1 were dosed into the dosing chamber of the dishwasher before each cleaning cycle (due to its weight content in PEG, the inventive agent E1 contains less active detergent or cleaning ingredients than the agent V1). The cleaning results were examined at the conclusion of the cleaning.

TABLE 3
Cleaning performance:

| | V1 | E1 |
|---|---|---|
| Tea | 3 | 4, 5 |
| Milk | 6 | 7 |
| Burnt mincemeat | 7 | 8 |
| Starch | 6 | 7 |

Evaluation scale: 0 = heavy soiling to 10 = no soiling

From Table 3 it can be seen that despite the lower use of active detergent or cleaning substances in the inventive agent E1, it exhibits an improved cleaning performance compared with the conventional agent V1.

Rinse Performance

Standardized ballast dirt and the formulations V1 and E1 were subjected to a cleaning cycle at 45° C. and 21° d in an automatic dishwasher (Bosch 5302) in order to test the rinse performance. 25 g of the cleaning agent V1 and E1 were dosed into the dosing chamber of the dishwasher before each cleaning cycle (due to its weight content in PEG, the inventive agent E1 contains less active detergent or cleaning ingredients than the agent V1). The rinsing results were examined at the conclusion of the cleaning.

TABLE 4
Rinse performance:

| | V1 | E1 |
|---|---|---|
| Glass | 4 | 4, 5 |
| Steel (stainless) | 4 | 4, 5 |
| Porcelain | 7 | 7 |

Evaluation scale: 0 = heavy film and spot formation to 10 = no film or spot formation

From Table 4 it can be seen that in spite of the lower use of active detergent or cleaning substances in the inventive agent E1, it exhibits an improved rinse performance compared with the conventional agent V1.

Silver Corrosion Protection:

Both automatic dishwasher agents V1 and E1 containing manganese sulfate were tested for their silver corrosion protective properties. Silver cutlery was washed in a continuously operating dishwasher at a water hardness of 0-1° dH. 25 g of the cleaning agent V1 were dosed for each cycle in the comparative example V1 and 25 g of agent E1 were dosed for the inventive example. The rinse cycle (as described above) was repeated 50 times. The global appearance of the washed ware was evaluated using the evaluation scale described below.

TABLE 5
Silver corrosion protection:

| | V1 | E1 |
|---|---|---|
| Note | 2.4 | 1.5 |

Evaluation scale: 0 = no corrosion to 4 = heavy corrosion

Table 5 shows that the inventive agent El, which comprises the silver corrosion protection agent in the inventive dispersion, shows markedly better silver corrosion protection properties than the conventional dishwasher agent, under the cited conditions.

1. A detergent or cleaning agent, comprising
a first active detergent or cleaning preparation in the form of a dispersion of solid particles in a dispersion agent, which, based on the total weight of the dispersion, comprises
i) 10 to 90 wt. % dispersion agent and
ii) 10 to 90 wt. % dispersed material,
wherein the detergent or cleaning agent comprises at least one additional active detergent or cleaning preparation, which dissolves faster in water at 40° C. than the first detergent or cleaning preparation.

2. The detergent or cleaning agent according to claim 1, wherein the dispersion of solid particles dissolves in water (40° C.) in less than 12 minutes, preferably less than 10 minutes.

3. The detergent or cleaning agent according to claim 1, wherein at least one dispersion agent is selected from the group consisting of water-soluble or water-dispersible nonionic polymers.

4. The detergent or cleaning agent according to claim 1, wherein at least one dispersion agent is selected from the group consisting of nonionic surfactants.

5. The detergent or cleaning agent according to claim 1, wherein the dispersion, based on the total weight of the detergent or cleaning agent, comprises at least 30 wt. % of the total nonionic surfactant comprised in the detergent or cleaning agent.

6. The detergent or cleaning agent according to claim 1, wherein at least one of the dispersed materials is selected from the group consisting of builders, active detergent, cleaning anionic, cationic and amphoteric polymers, bleaching agents, bleach activators, silver protection agents, glass corrosion protection agents and enzymes.

7. The detergent or cleaning agent according to claim 1, wherein the dispersed materials, based on the total weight of the detergent or cleaning agent, comprise at least 30 wt. % of the total anionic, cationic and amphoteric polymer comprised in the detergent or cleaning agent.

8. The detergent or cleaning agent according to claim 1, characterized in that the dispersion is a liquid (20° C.) with a viscosity (Brookfield-Viscosimeter LVT-II at 20 rpm and 20° C., spindle 3) in the range from 50 to 100 000 mPas.

9. The detergent or cleaning agent according to-Claim 1, wherein the dispersion is a dimensionally stable solid matter at 20° C.

10. The detergent or cleaning agent according to claim 1, wherein the dispersion has a density between 0.80 and 1.70 g/cm³.

11. The detergent or cleaning agent according to claim 1, wherein the additional active detergent or cleaning preparation is at least one solid.

12. The detergent or cleaning agent according to claim 1, wherein the additional active detergent or cleaning preparation is a gel.

13. The detergent or cleaning agent according to claim 1, wherein the additional active detergent or cleaning preparation has a density between 0.80 and 1.70 g/cm³.

14. The detergent or cleaning agent according to claim 1, wherein the first detergent or cleaning preparation forms a hollow body, in the cavity of which the additional active detergent or cleaning preparation is at least partially included.

15. A detergent or cleaning agent, comprising
a first active detergent or cleaning preparation in the form of a dispersion of solid particles in a dispersion agent, which, based on the total weight of the dispersion, comprises
i) 10 to 90 wt. % dispersion agent and
ii) 10 to 90 wt. % dispersed material,
wherein the detergent or cleaning agent comprises at least one additional active detergent or cleaning preparation, which dissolves faster in water at 40° C. than the first detergent or cleaning preparation and has a water-soluble or water-dispersible packaging.

16. The detergent or cleaning agent according to claim 15, wherein the water-soluble or water-dispersible packaging was manufactured, at least partially, by deep drawing or injection molding or casting.

17. The detergent or cleaning agent according to claim 15, wherein the water-soluble packaging comprises at least one water-soluble or water-dispersible container and/or at least a water-soluble or water-dispersible closure, wherein the container and/or the closure has a wall thickness below 200 μm.

18. The detergent or cleaning agent according to claim 15, wherein the first active detergent or cleaning composition in the water-soluble or water-dispersible packaging is separated, at least partially, from the second active detergent or cleaning composition.

19. A detergent or cleaning agent cast body comprising a first active detergent or cleaning preparation in the form of a dispersion of solid particles in a dispersion agent, which, based on its total weight, comprises
a) 10 to 65 wt. % dispersion agent and
b) 30 to 90 wt. % dispersed materials,
wherein the detergent or cleaning agent comprises an additional detergent or cleaning agent that dissolves more quickly in water at 40° C. than the first detergent and cleaning preparation, whereby the cast body has a receiving chamber or cavity, which is at least partially filled with a cleaning agent component that comprises
c) 5 to 95 wt. % surfactant and
d) 5 to 95 wt. % meltable substance(s) with a melting point above 30° C. and a solubility in water of less than 20 g/l at 20° C.
e) as well as optional additional constituents of detergent or cleaning agents.

20. A process for cleaning dishes in a dishwasher, in which a detergent or cleaning agent according to claim 1 is inserted into the inside of the dishwasher, prior to the cleaning cycle.
